(19) United States
(12) Patent Application Publication
(10) Pub. No.: US 2026/0024230 A1
(43) Pub. Date: Jan. 22, 2026

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Hyejung HUR, Seoul (KR); Yousun PARK, Seoul (KR)

(73) Assignee: LG ELECTRONICS INC., Seoul (KR)

(21) Appl. No.: 18/996,753

(22) PCT Filed: Aug. 29, 2023
(86) PCT No.: PCT/KR2023/012747

§ 371 Date: Jan. 17, 2025

(30) Foreign Application Priority Data
Aug. 30, 2022 (KR) 10-2022-0109131

(51) Int. Cl. G06T 9/00; G06T 9/40; H04N 19/70

(52) U.S. Cl. CPC G06T 9/001; G06T 9/40; H04N 19/70

(57) ABSTRACT

A point cloud data transmission method according to embodiments may comprise the steps of: encoding point cloud data; and transmitting a bitstream comprising the point cloud data. A point cloud data reception method according to embodiments may comprise the steps of: receiving a bitstream comprising point cloud data; and decoding the point cloud data.

This application is a National Phase entry pursuant to 35 U.S.C. § 371 of International Application No. PCT/KR2023/0012747, filed on Aug. 29, 2023, which claims the benefit of Korean Application No. 10-2022-0109131 filed Aug. 30, 2022, the disclosure which are incorporated herein by reference in their entirety.

### TECHNICAL FIELD

Embodiments relate to a method and device for processing point cloud content.

### BACKGROUND

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), and self-driving services. However, tens of thousands to hundreds of thousands of point data are required to represent point cloud content. Therefore, there is a need for a method for efficiently processing a large amount of point data.

### SUMMARY

Embodiments provide a device and method for efficiently processing point cloud data. Embodiments provide a point cloud data processing method and device for addressing latency and encoding/decoding complexity.

The technical scope of the embodiments is not limited to the aforementioned technical objects, and may be extended to other technical objects that may be inferred by those skilled in the art based on the entire contents disclosed herein.

In one aspect of the present disclosure, a method of transmitting point cloud data may include encoding point cloud data, and transmitting a bitstream containing the point cloud data. In another aspect of the present disclosure, a method of receiving point cloud data may include receiving a bitstream containing point cloud data, and decoding the point cloud data.

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts.

FIG. 1 shows an exemplary point cloud content providing system according to embodiments;

FIG. 2 is a block diagram illustrating a point cloud content providing operation according to embodiments;

FIG. 3 illustrates an exemplary point cloud encoder according to embodiments;

FIG. 4 shows an example of an octree and occupancy code according to embodiments;

FIG. 5 illustrates an example of point configuration in each LOD according to embodiments;

FIG. 6 illustrates an example of point configuration in each LOD according to embodiments;

FIG. 7 illustrates a point cloud decoder according to embodiments;

FIG. 8 illustrates a transmission device according to embodiments;

FIG. 9 illustrates a reception device according to embodiments;

FIG. 10 illustrates an exemplary structure operable in connection with point cloud data transmission/reception methods/devices according to embodiments;

FIG. 11 illustrates a predictive tree according to embodiments;

FIG. 12 illustrates an inter-frame predictive tree-based geometry compression/reconstruction method according to embodiments;

FIG. 13 illustrates an intra-frame object search method according to embodiments;

FIG. 14 illustrates a point cloud data transmission device according to embodiments;

FIG. 15 illustrates a point cloud data reception device according to embodiments;

FIG. 16 illustrates a bitstream containing point cloud data and parameters according to embodiments;

FIG. 17 illustrates a frame parameter set (FPS) according to embodiments;

FIG. 18 illustrates a sequence parameter set (SPS) according to embodiments;

FIG. 19 illustrates a tile parameter set (TPS) according to embodiments;

FIG. 20 illustrates a geometry parameter set (GPS) according to embodiments;

FIG. 21 illustrates an attribute parameter set (APS) according to embodiments;

FIG. 22 illustrates a geometry slice header (GSH) according to embodiments;

FIG. 23 illustrates a point cloud data transmission method according to embodiments;

FIG. 24 illustrates a point cloud data reception method according to embodiments.

### DETAILED DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

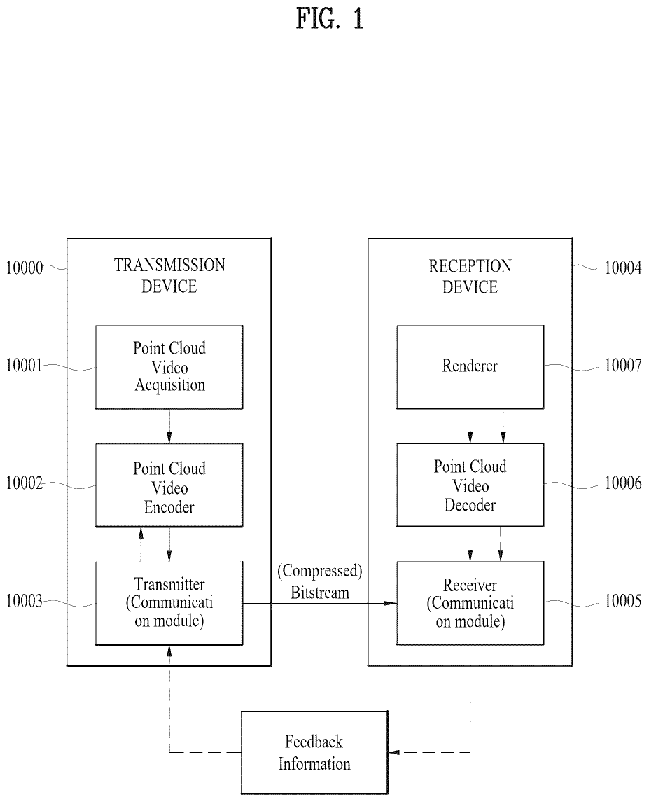

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data, point cloud data, or the like. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

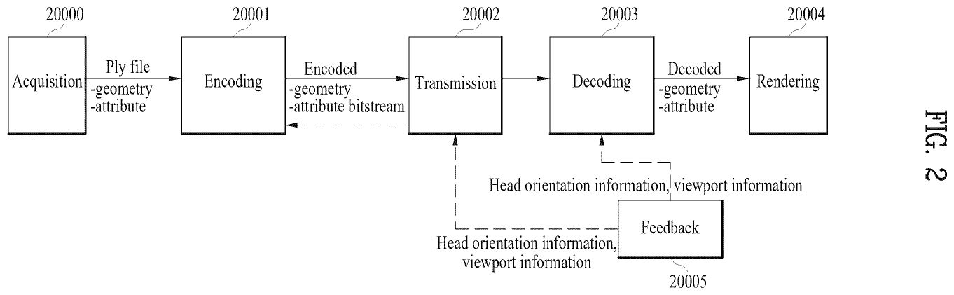

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, position information, position data, or the like, and the attribute may be called attributes, attribute information, attribute data, or the like. The point cloud content providing system (e.g., the point cloud transmission device 10000 or the point cloud video acquirer 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry information and attribute information about a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus a detailed description thereof is omitted.

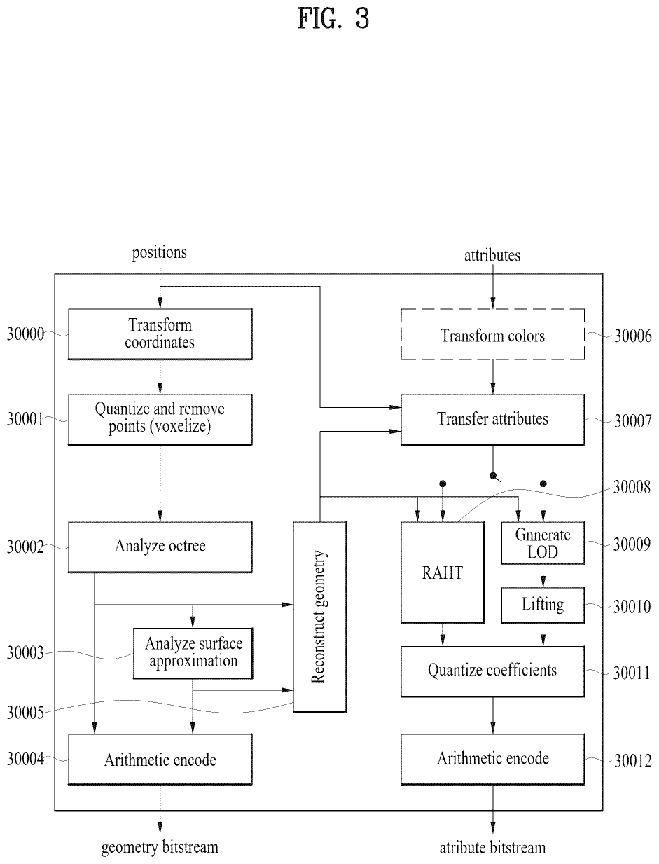

FIG. 3 illustrates an exemplary point cloud encoder according to embodiments.

FIG. 3 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes coordinate transformer (Transform coordinates) 30000, a quantizer (Quantize and remove points (voxelize)) 30001, an octree analyzer (Analyze octree) 30002, and a surface approximation analyzer (Analyze surface approximation) 30003, an arithmetic encoder (Arithmetic encode) 30004, a geometry reconstructor (Reconstruct geometry) 30005, a color transformer (Transform colors) 30006, an attribute transformer (Transform attributes) 30007, a RAHT transformer (RAHT) 30008, an LOD generator (Generate LOD) 30009, a lifting transformer (Lifting) 30010, a coefficient quantizer (Quantize coefficients) 30011, and/or an arithmetic encoder (Arithmetic encode) 30012.

The coordinate transformer 30000, the quantizer 30001, the octree analyzer 30002, the surface approximation analyzer 30003, the arithmetic encoder 30004, and the geometry reconstructor 30005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 30000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 30001 according to the embodiments quantizes the geometry. For example, the quantizer 30001 may quantize the points based on a minimum position value of all points (e.g., a minimum value on each of the X, Y, and Z axes). The quantizer 30001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 30001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 30001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 30002 according to the embodiments performs octree geometry coding (or octree coding) to present voxels in an octree structure. The octree structure represents points matched with voxels, based on the octal tree structure.

The surface approximation analyzer 30003 according to the embodiments may analyze and approximate the octree. The octree analysis and approximation according to the embodiments is a process of analyzing a region containing a plurality of points to efficiently provide octree and voxelization.

The arithmetic encoder 30004 according to the embodiments performs entropy encoding on the octree and/or the approximated octree. For example, the encoding scheme includes arithmetic encoding. As a result of the encoding, a geometry bitstream is generated.

The color transformer 30006, the attribute transformer 30007, the RAHT transformer 30008, the LOD generator 30009, the lifting transformer 30010, the coefficient quantizer 30011, and/or the arithmetic encoder 30012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 30006 according to the embodiments performs color transform coding of transforming color values (or textures) included in the attributes. For example, the color transformer 30006 may transform the format of color information (for example, from RGB to YCbCr). The operation of the color transformer 30006 according to embodiments may be optionally applied according to the color values included in the attributes.

The geometry reconstructor 30005 according to the embodiments reconstructs (decompresses) the octree and/or the approximated octree. The geometry reconstructor 30005 reconstructs the octree/voxels based on the result of analyzing the distribution of points. The reconstructed octree/voxels may be referred to as reconstructed geometry (restored geometry).

The attribute transformer 30007 according to the embodiments performs attribute transformation to transform the attributes based on the reconstructed geometry and/or the positions on which geometry encoding is not performed. As described above, since the attributes are dependent on the geometry, the attribute transformer 30007 may transform the attributes based on the reconstructed geometry information. For example, based on the position value of a point included in a voxel, the attribute transformer 30007 may transform the attribute of the point at the position. As described above, when the position of the center of a voxel is set based on the positions of one or more points included in the voxel, the attribute transformer 30007 transforms the attributes of the one or more points. When the trisoup geometry encoding is performed, the attribute transformer 30007 may transform the attributes based on the trisoup geometry encoding.

The attribute transformer 30007 may perform the attribute transformation by calculating the average of attributes or attribute values of neighboring points (e.g., color or reflectance of each point) within a specific position/radius from the position (or position value) of the center of each voxel. The attribute transformer 30007 may apply a weight according to the distance from the center to each point in calculating the average. Accordingly, each voxel has a position and a calculated attribute (or attribute value).

The attribute transformer 30007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 30007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 30009.

The RAHT transformer 30008 according to the embodiments performs RAHT coding for predicting attribute information based on the reconstructed geometry information. For example, the RAHT transformer 30008 may predict attribute information of a node at a higher level in the octree based on the attribute information associated with a node at a lower level in the octree.

The LOD generator 30009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 30010 according to the embodiments performs lifting transform coding of transforming the attributes a point cloud based on weights. As described above, lifting transform coding may be optionally applied.

The coefficient quantizer 30011 according to the embodiments quantizes the attribute-coded attributes based on coefficients.

The arithmetic encoder 30012 according to the embodiments encodes the quantized attributes based on arithmetic coding.

Although not shown in the figure, the elements of the point cloud encoder of FIG. 3 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 3 described above. Additionally, the one or more processors may operate or execute a set of software programs and/or instructions for performing the operations and/or functions of the elements of the point cloud encoder of FIG. 3. The one or more memories according to the embodiments may include a high speed random access memory, or include a non-volatile memory (e.g., one or more magnetic disk storage devices, flash memory devices, or other non-volatile solid-state memory devices).

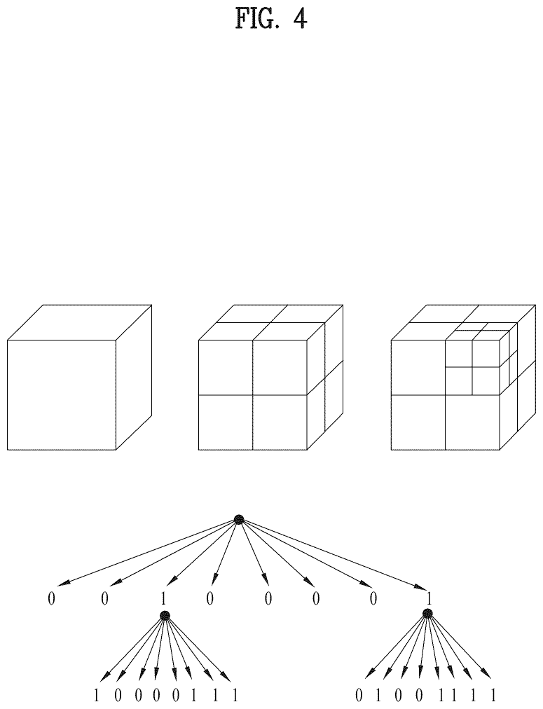

FIG. 4 shows an example of an octree and occupancy code according to embodiments.

As described with reference to FIGS. 1 to 3, the point cloud content providing system (point cloud video encoder 10002) or the point cloud encoder (e.g., the octree analyzer 30002) performs octree geometry coding (or octree coding) based on an octree structure to efficiently manage the region and/or position of the voxel.

The upper part of FIG. 4 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2d may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

$$d = Ceil ( Log 2 ( Max ( x\_n \hat{} int , y\_n \hat{} int , z\_n \hat{} in , n = 1 , … , N ) + 1 ) )$$

As shown in the middle of the upper part of FIG. 4, the entire 3D space may be divided into eight spaces according to partition. Each divided space is represented by a cube with six faces. As shown in the upper right of FIG. 4, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 4 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 4 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (e.g., the arithmetic encoder 30004) according to the embodiments may perform entropy encoding on the occupancy codes. In order to increase the compression efficiency, the point cloud encoder may perform intra/inter-coding on the occupancy codes. The reception device (e.g., the reception device 10004 or the point cloud video decoder 10006) according to the embodiments reconstructs the octree based on the occupancy codes.

The point cloud encoder (e.g., the point cloud encoder of FIG. 4 or the octree analyzer 30002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 30004) according to the embodiments may perform entropy coding on the positions (or position values) of the points.

The point cloud encoder (e.g., the surface approximation analyzer 30003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (e.g., the geometry reconstructor 30005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$○ 1 [ \begin{matrix}{μ}_{x} \\ {μ}_{y} \\ {μ}_{z}\end{matrix} ] = \frac{1}{N} {\sum }_{i = 1}^{n} [ \begin{matrix}{x}_{i} \\ {y}_{i} \\ {z}_{i}\end{matrix} ]$$

$$○ 2 [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ]$$

$$○ 3 [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ]$$

The minimum value of the sum is estimated, and the projection process is performed according to the axis with the minimum value. For ‘example, when the element x is the minimum, each vertex is projected on the x-axis with respect to the center of the block, and projected on the (y, z) plane. When the values obtained through projection on the (y, z) plane are (ai, bi), the value of θ is estimated through atan2 (bi, ai), and the vertices are ordered based on the value of 0. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 2-1
Triangles formed from vertices ordered 1, . . . , n

| n | triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), |
| | (9, 1, 5) |
| 11 | (1, 2, 3), (3, 4, 5), (5, 6, 7), (7, 8, 9), (9, 10, 11), (11, 1, 3), (3, 5, 7), |
| | (7, 9, 11), (11, 3, 7) |
| 12 | (1, 2, 3), (3, 4, 5), (5, 6, 7), (7, 8, 9), (9, 10, 11), (11, 12, 1), |
| | (1, 3, 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

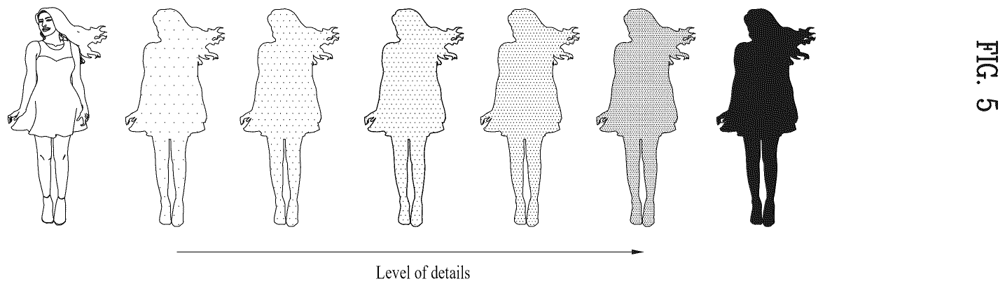

FIG. 5 illustrates an example of point configuration in each LOD according to embodiments.

As described with reference to FIGS. 1 to 4, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (e.g., the LOD generator 30009) may classify (or reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

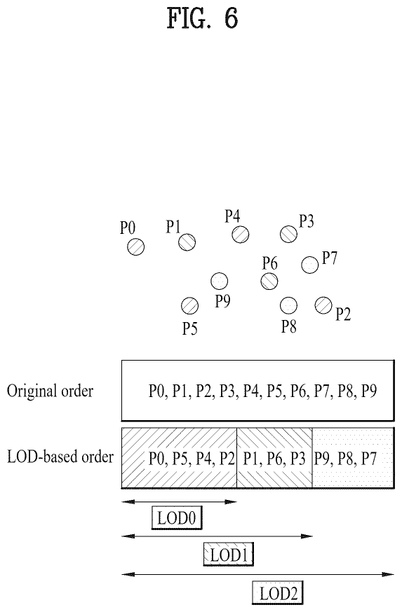

FIG. 6 illustrates an example of point configuration for each LOD according to embodiments.

As described with reference to FIGS. 1 to 5, the point cloud content providing system, or the point cloud encoder (e.g., the point cloud video encoder 10002, the point cloud encoder of FIG. 3, or the LOD generator 30009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 6 shows examples (P0 to P9) of points of the point cloud content distributed in a 3D space. In FIG. 6, the original order represents the order of points P to P9 before LOD generation. In FIG. 6, the LOD based order represents the order of points according to the LOD generation. Points are reorganized by LOD. Also, a high LOD contains the points belonging to lower LODs. As shown in FIG. 6, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 3, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (e.g., the coefficient quantizer 30011) may quantize and inversely quantize the residuals (which may be called residual attributes, residual attribute values, or attribute prediction residuals, attribute residuals) obtained by subtracting a predicted attribute (attribute value) from the attribute (attribute value) of each point. The quantization process is configured as shown in the following table.

TABLE. Attribute prediction residuals quantization pseudo code
int PCCQuantization(int value, int quantStep) {
if( value >=0) {
return floor(value / quantStep + 1.0 / 3.0);
} else {
return −floor(−value / quantStep + 1.0 / 3.0);
}
}
TABLE. Attribute prediction residuals inverse quantization pseudo code
int PCCInverseQuantization(int value, int quantStep) {
if( quantStep ==0) {
return value;
} else {
return value * quantStep;
}
}

When the predictor of each point has neighbor points, the point cloud encoder (e.g., the arithmetic encoder 30012) according to the embodiments may perform entropy coding on the quantized and inversely quantized residual values as described above. When the predictor of each point has no neighbor point, the point cloud encoder according to the embodiments (e.g., the arithmetic encoder 30012) may perform entropy coding on the attributes of the corresponding point without performing the above-described operation.

The point cloud encoder according to the embodiments (e.g., the lifting transformer 30010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud encoder (e.g., coefficient quantizer 30011) according to the embodiments quantizes the predicted attribute values. In addition, the point cloud encoder (e.g., the arithmetic encoder 30012) performs entropy coding on the quantized attribute values.

The point cloud encoder (for example, the RAHT transformer 30008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉ , {T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 300012). The weights are calculated as wₗ₋₁_{_{x,y,z}}=wₗ_{_{2x,y,z}}+wₗ_{_{2x+1,y,z}}. The root node is created through the g₁_{_{0,0,0}} and g₁_{_{0,0,1}} as follows.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉$$

The value of gDC is also quantized and subjected to entropy coding like the high-pass coefficients.

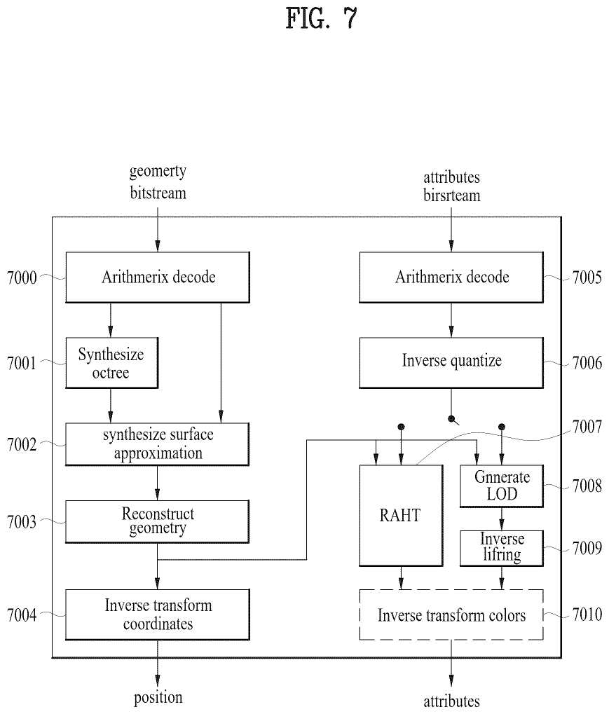

FIG. 7 illustrates a point cloud decoder according to embodiments.

The point cloud decoder illustrated in FIG. 7 is an example of the point cloud decoder and may perform a decoding operation, which is a reverse process to the encoding operation of the point cloud encoder illustrated in FIGS. 1 to 6.

As described with reference to FIGS. 1 and 6, the point cloud decoder may perform geometry decoding and attribute decoding. The geometry decoding is performed before the attribute decoding.

The point cloud decoder according to the embodiments includes an arithmetic decoder (Arithmetic decode) 7000, an octree synthesizer (Synthesize octree) 7001, a surface approximation synthesizer (Synthesize surface approximation) 7002, and a geometry reconstructor (Reconstruct geometry) 7003, a coordinate inverse transformer (Inverse transform coordinates) 7004, an arithmetic decoder (Arithmetic decode) 7005, an inverse quantizer (Inverse quantize) 7006, a RAHT transformer 7007, an LOD generator (Generate LOD) 7008, an inverse lifter (inverse lifting) 7009, and/or a color inverse transformer (Inverse transform colors) 7010.

The arithmetic decoder 7000, the octree synthesizer 7001, the surface approximation synthesizer 7002, and the geometry reconstructor 7003, and the coordinate inverse transformer 7004 may perform geometry decoding. The geometry decoding according to the embodiments may include direct decoding and trisoup geometry decoding. The direct coding and trisoup geometry decoding are selectively applied. The geometry decoding is not limited to the above-described example, and is performed as a reverse process to the geometry encoding described with reference to FIGS. 1 to 6.

The arithmetic decoder 7000 according to the embodiments decodes the received geometry bitstream based on the arithmetic coding. The operation of the arithmetic decoder 7000 corresponds to the reverse process to the arithmetic encoder 30004.

The octree synthesizer 7001 according to the embodiments may generate an octree by acquiring an occupancy code from the decoded geometry bitstream (or information on the geometry secured as a result of decoding). The occupancy code is configured as described in detail with reference to FIGS. 1 to 6.

When the trisoup geometry encoding is applied, the surface approximation synthesizer 7002 according to the embodiments may synthesize a surface based on the decoded geometry and/or the generated octree.

The geometry reconstructor 7003 according to the embodiments may regenerate geometry based on the surface and/or the decoded geometry. As described with reference to FIGS. 1 to 9, direct coding and trisoup geometry encoding are selectively applied. Accordingly, the geometry reconstructor 7003 directly imports and adds position information about the points to which direct coding is applied. When the trisoup geometry encoding is applied, the geometry reconstructor 7003 may reconstruct the geometry by performing the reconstruction operations of the geometry reconstructor 30005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 7004 according to the embodiments may acquire positions of the points by transforming the coordinates based on the reconstructed geometry.

The arithmetic decoder 7005, the inverse quantizer 7006, the RAHT transformer 7007, the LOD generator 7008, the inverse lifter 7009, and/or the color inverse transformer 7010 may perform the attribute decoding described with reference to FIG. 6. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 7005 according to the embodiments decodes the attribute bitstream by arithmetic coding.

The inverse quantizer 7006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 7007, the LOD generator 7008, and/or the inverse lifter 7009 may process the reconstructed geometry and the inversely quantized attributes. As described above, the RAHT transformer 7007, the LOD generator 7008, and/or the inverse lifter 7009 may selectively perform a decoding operation corresponding to the encoding of the point cloud encoder.

The color inverse transformer 7010 according to the embodiments performs inverse transform coding to inversely transform a color value (or texture) included in the decoded attributes. The operation of the color inverse transformer 7010 may be selectively performed based on the operation of the color transformer 30006 of the point cloud encoder.

Although not shown in the figure, the elements of the point cloud decoder of FIG. 7 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 7 described above. Additionally, the one or more processors may operate or execute a set of software programs and/or instructions for performing the operations and/or functions of the elements of the point cloud decoder of FIG. 7.

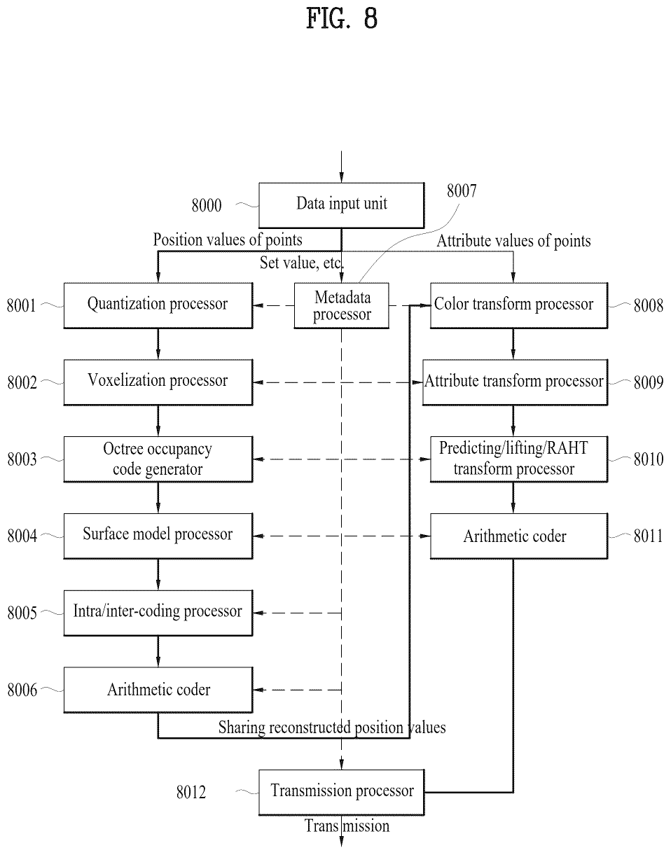

FIG. 8 illustrates a transmission device according to embodiments.

The transmission device shown in FIG. 8 is an example of the transmission device 10000 of FIG. 1 (or the point cloud encoder of FIG. 3). The transmission device illustrated in FIG. 8 may perform one or more of the operations and methods the same as or similar to those of the point cloud encoder described with reference to FIGS. 1 to 6. The transmission device according to the embodiments may include a data input unit 8000, a quantization processor 8001, a voxelization processor 8002, an octree occupancy code generator 8003, a surface model processor 8004, an intra/inter-coding processor 8005, an arithmetic coder 8006, a metadata processor 8007, a color transform processor 8008, an attribute transform processor 8009, a prediction/lifting/RAHT transform processor 8010, an arithmetic coder 8011 and/or a transmission processor 8012.

The data input unit 8000 according to the embodiments receives or acquires point cloud data. The data input unit 8000 may perform an operation and/or acquisition method the same as or similar to the operation and/or acquisition method of the point cloud video acquirer 10001 (or the acquisition process 20000 described with reference to FIG. 2).

The data input unit 8000, the quantization processor 8001, the voxelization processor 8002, the octree occupancy code generator 8003, the surface model processor 8004, the intra/inter-coding processor 8005, and the arithmetic coder 8006 perform geometry encoding. The geometry encoding according to the embodiments is the same as or similar to the geometry encoding described with reference to FIGS. 1 to 9, and thus a detailed description thereof is omitted.

The quantization processor 8001 according to the embodiments quantizes geometry (e.g., position values of points). The operation and/or quantization of the quantization processor 8001 is the same as or similar to the operation and/or quantization of the quantizer 30001 described with reference to FIG. 3. Details are the same as those described with reference to FIGS. 1 to 9.

The voxelization processor 8002 according to the embodiments voxelizes the quantized position values of the points. The voxelization processor 8002 may perform an operation and/or process the same or similar to the operation and/or the voxelization process of the quantizer 30001 described with reference to FIG. 3. Details are the same as those described with reference to FIGS. 1 to 6.

The octree occupancy code generator 8003 according to the embodiments performs octree coding on the voxelized positions of the points based on an octree structure. The octree occupancy code generator 8003 may generate an occupancy code. The octree occupancy code generator 8003 may perform an operation and/or method the same as or similar to the operation and/or method of the point cloud encoder (or the octree analyzer 30002) described with reference to FIGS. 3 and 4. Details are the same as those described with reference to FIGS. 1 to 6.

The surface model processor 8004 according to the embodiments may perform trisoup geometry encoding based on a surface model to reconstruct the positions of points in a specific region (or node) on a voxel basis. The surface model processor 8004 may perform an operation and/or method the same as or similar to the operation and/or method of the point cloud encoder (e.g., the surface approximation analyzer 30003) described with reference to FIG. 3. Details are the same as those described with reference to FIGS. 1 to 6.

The intra/inter-coding processor 8005 according to the embodiments may perform intra/inter-coding on point cloud data. The intra/inter-coding processor 8005 may perform coding the same as or similar to the intra/inter-coding described with reference to FIG. 7. Details are the same as those described with reference to FIG. 7. According to embodiments, the intra/inter-coding processor 8005 may be included in the arithmetic coder 8006.

The arithmetic coder 8006 according to the embodiments performs entropy encoding on an octree of the point cloud data and/or an approximated octree. For example, the encoding scheme includes arithmetic encoding. The arithmetic coder 8006 performs an operation and/or method the same as or similar to the operation and/or method of the arithmetic encoder 30004.

The metadata processor 8007 according to the embodiments processes metadata about the point cloud data, for example, a set value, and provides the same to a necessary processing process such as geometry encoding and/or attribute encoding. Also, the metadata processor 8007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 8008, the attribute transform processor 8009, the prediction/lifting/RAHT transform processor 8010, and the arithmetic coder 8011 perform the attribute encoding. The attribute encoding according to the embodiments is the same as or similar to the attribute encoding described with reference to FIGS. 1 to 6, and thus a detailed description thereof is omitted.

The color transform processor 8008 according to the embodiments performs color transform coding to transform color values included in attributes. The color transform processor 8008 may perform color transform coding based on the reconstructed geometry. The reconstructed geometry is the same as described with reference to FIGS. 1 to 9. Also, it performs an operation and/or method the same as or similar to the operation and/or method of the color transformer 30006 described with reference to FIG. 3 is performed. A detailed description thereof is omitted.

The attribute transform processor 8009 according to the embodiments performs attribute transformation to transform the attributes based on the reconstructed geometry and/or the positions on which geometry encoding is not performed. The attribute transform processor 8009 performs an operation and/or method the same as or similar to the operation and/or method of the attribute transformer 30007 described with reference to FIG. 3. A detailed description thereof is omitted. The prediction/lifting/RAHT transform processor 8010 according to the embodiments may code the transformed attributes by any one or a combination of RAHT coding, prediction transform coding, and lifting transform coding. The prediction/lifting/RAHT transform processor 8010 performs at least one of the operations the same as or similar to the operations of the RAHT transformer 30008, the LOD generator 30009, and the lifting transformer 30010 described with reference to FIG. 3. In addition, the prediction transform coding, the lifting transform coding, and the RAHT transform coding are the same as those described with reference to FIGS. 1 to 9, and thus a detailed description thereof is omitted.

The arithmetic coder 8011 according to the embodiments may encode the coded attributes based on the arithmetic coding. The arithmetic coder 8011 performs an operation and/or method the same as or similar to the operation and/or method of the arithmetic encoder 300012.

The transmission processor 8012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom00 and one or more attribute bitstreams Attr00 and Attr10.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 8007 according to the embodiments may generate and/or process the signaling information and transmit the same to the transmission processor 8012. According to embodiments, the elements to perform geometry encoding and the elements to perform attribute encoding may share data/information with each other as indicated by dotted lines. The transmission processor 8012 according to the embodiments may perform an operation and/or transmission method the same as or similar to the operation and/or transmission method of the transmitter 10003. Details are the same as those described with reference to FIGS. 1 and 2, and thus a description thereof is omitted.

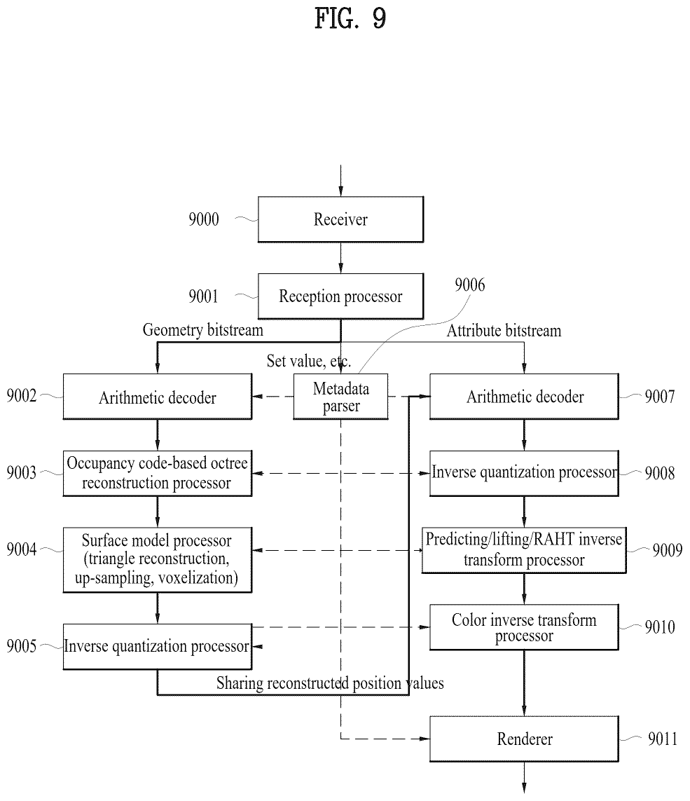

FIG. 9 illustrates a reception device according to embodiments.

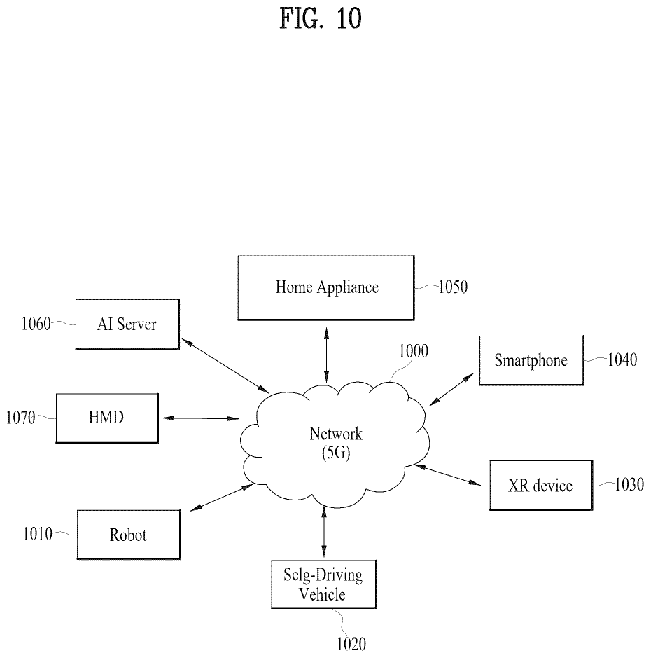

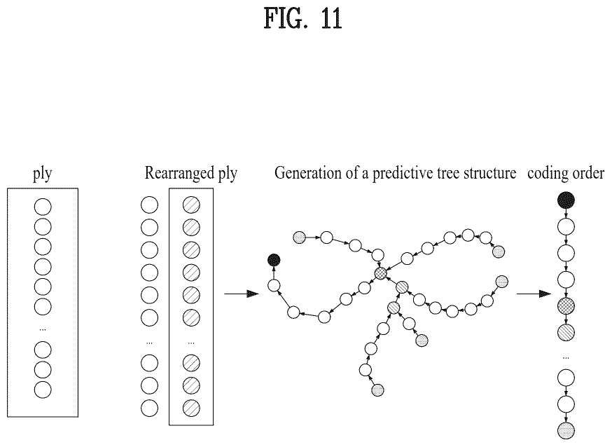

The reception device illustrated in FIG. 9 is an example of the reception device 10004 of FIG. 1 (or the point cloud decoder of FIGS. 10 and 11). The reception device illustrated in FIG. 9 may perform one or more of the operations and methods the same as or similar to those of the point cloud decoder described with reference to FIGS. 1 to 11.

The reception device according to the embodiment may include a receiver 9000, a reception processor 9001, an arithmetic decoder 9002, an occupancy code-based octree reconstruction processor 9003, a surface model processor (triangle reconstruction, up-sampling, voxelization) 9004, an inverse quantization processor 9005, a metadata parser 9006, an arithmetic decoder 9007, an inverse quantization processor 9008, a prediction/lifting/RAHT inverse transform processor 9009, a color inverse transform processor 9010, and/or a renderer 9011. Each element for decoding according to the embodiments may perform a reverse process to the operation of a corresponding element for encoding according to the embodiments.

The receiver 9000 according to the embodiments receives point cloud data. The receiver 9000 may perform an operation and/or reception method the same as or similar to the operation and/or reception method of the receiver 10005 of FIG. 1. The detailed description thereof is omitted.

The reception processor 9001 according to the embodiments may acquire a geometry bitstream and/or an attribute bitstream from the received data. The reception processor 9001 may be included in the receiver 9000.

The arithmetic decoder 9002, the occupancy code-based octree reconstruction processor 9003, the surface model processor 9004, and the inverse quantization processor 905 may perform geometry decoding. The geometry decoding according to embodiments is the same as or similar to the geometry decoding described with reference to FIGS. 1 to 10, and thus a detailed description thereof is omitted.

The arithmetic decoder 9002 according to the embodiments may decode the geometry bitstream based on arithmetic coding. The arithmetic decoder 9002 performs an operation and/or coding the same as or similar to the operation and/or coding of the arithmetic decoder 7000.

The occupancy code-based octree reconstruction processor 9003 according to the embodiments may reconstruct an octree by acquiring an occupancy code from the decoded geometry bitstream (or information about the geometry secured as a result of decoding). The occupancy code-based octree reconstruction processor 9003 performs an operation and/or method the same as or similar to the operation and/or octree generation method of the octree synthesizer 7001. When the trisoup geometry encoding is applied, the surface model processor 9004 according to the embodiments may perform trisoup geometry decoding and related geometry reconstruction (e.g., triangle reconstruction, up-sampling, voxelization) based on the surface model method. The surface model processor 9004 performs an operation the same as or similar to that of the surface approximation synthesizer 7002 and/or the geometry reconstructor 7003.

The inverse quantization processor 9005 according to the embodiments may inversely quantize the decoded geometry.

The metadata parser 9006 according to the embodiments may parse metadata contained in the received point cloud data, for example, a set value. The metadata parser 9006 may pass the metadata to geometry decoding and/or attribute decoding. The metadata is the same as that described with reference to FIG. 8, and thus a detailed description thereof is omitted.

The arithmetic decoder 9007, the inverse quantization processor 9008, the prediction/lifting/RAHT inverse transform processor 9009 and the color inverse transform processor 9010 perform attribute decoding. The attribute decoding is the same as or similar to the attribute decoding described with reference to FIGS. 1 to 10, and thus a detailed description thereof is omitted.

The arithmetic decoder 9007 according to the embodiments may decode the attribute bitstream by arithmetic coding. The arithmetic decoder 9007 may decode the attribute bitstream based on the reconstructed geometry. The arithmetic decoder 9007 performs an operation and/or coding the same as or similar to the operation and/or coding of the arithmetic decoder 7005.

The inverse quantization processor 9008 according to the embodiments may inversely quantize the decoded attribute bitstream. The inverse quantization processor 9008 performs an operation and/or method the same as or similar to the operation and/or inverse quantization method of the inverse quantizer 7006.

The prediction/lifting/RAHT inverse transform processor 9009 according to the embodiments may process the reconstructed geometry and the inversely quantized attributes. The prediction/lifting/RAHT inverse transform processor 9009 performs one or more of operations and/or decoding the same as or similar to the operations and/or decoding of the RAHT transformer 7007, the LOD generator 7008, and/or the inverse lifter 7009. The color inverse transform processor 9010 according to the embodiments performs inverse transform coding to inversely transform color values (or textures) included in the decoded attributes. The color inverse transform processor 9010 performs an operation and/or inverse transform coding the same as or similar to the operation and/or inverse transform coding of the color inverse transformer 7010. The renderer 9011 according to the embodiments may render the point cloud data.

FIG. 10 illustrates an exemplary structure operable in connection with point cloud data transmission/reception methods/devices according to embodiments.

The structure of FIG. 10 represents a configuration in which at least one of a server 1060, a robot 1010, a self-driving vehicle 1020, an XR device 1030, a smartphone 1040, a home appliance 1050, and/or a head-mount display (HMD) 1070 is connected to the cloud network 1000. The robot 1010, the self-driving vehicle 1020, the XR device 1030, the smartphone 1040, or the home appliance 1050 is called a device. Further, the XR device 1030 may correspond to a point cloud data (PCC) device according to embodiments or may be operatively connected to the PCC device.

The cloud network 1000 may represent a network that constitutes part of the cloud computing infrastructure or is present in the cloud computing infrastructure. Here, the cloud network 1000 may be configured using a 3G network, 4G or Long Term Evolution (LTE) network, or a 5G network.

The server 1060 may be connected to at least one of the robot 1010, the self-driving vehicle 1020, the XR device 1030, the smartphone 1040, the home appliance 1050, and/or the HMD 1070 over the cloud network 1000 and may assist in at least a part of the processing of the connected devices 1010 to 1070.

The HMD 1070 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1010 to 1050 to which the above-described technology is applied will be described. The devices 1010 to 1050 illustrated in FIG. 10 may be operatively connected/coupled to a point cloud data transmission device and reception device according to the above-described embodiments.

### <PCC+XR>

The XR/PCC device 1030 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1030 may analyze 3D point cloud data or image data acquired through various sensors or from an external device and generate position data and attribute data about 3D points. Thereby, the XR/PCC device 1030 may acquire information about the surrounding space or a real object, and render and output an XR object. For example, the XR/PCC device 1030 may match an XR object including auxiliary information about a recognized object with the recognized object and output the matched XR object.

<PCC+XR+Mobile phone>

The XR/PCC device 1030 may be implemented as a mobile phone 1040 by applying PCC technology.

The mobile phone 1040 may decode and display point cloud content based on the PCC technology.

### <PCC+Self-Driving+XR>

The self-driving vehicle 1020 may be implemented as a mobile robot, a vehicle, an unmanned aerial vehicle, or the like by applying the PCC technology and the XR technology.

The self-driving vehicle 1020 to which the XR/PCC technology is applied may represent a self-driving vehicle provided with means for providing an XR image, or a self-driving vehicle that is a target of control/interaction in the XR image. In particular, the self-driving vehicle 1020 which is a target of control/interaction in the XR image may be distinguished from the XR device 1030 and may be operatively connected thereto.

The self-driving vehicle 1020 having means for providing an XR/PCC image may acquire sensor information from sensors including a camera, and output the generated XR/PCC image based on the acquired sensor information. For example, the self-driving vehicle 1020 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

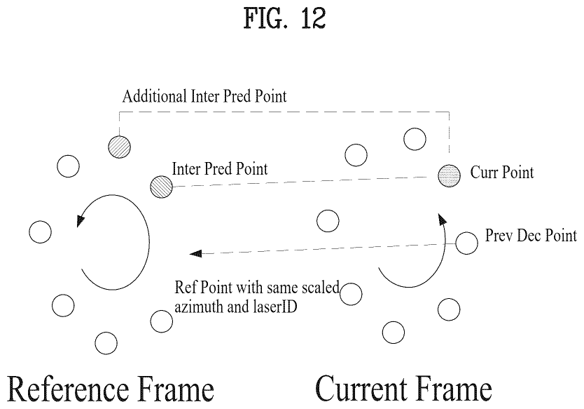

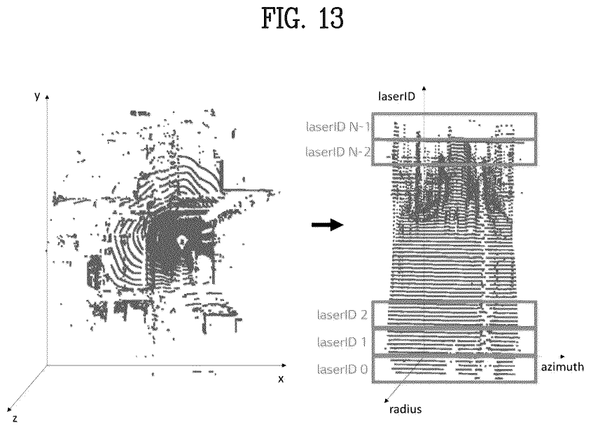

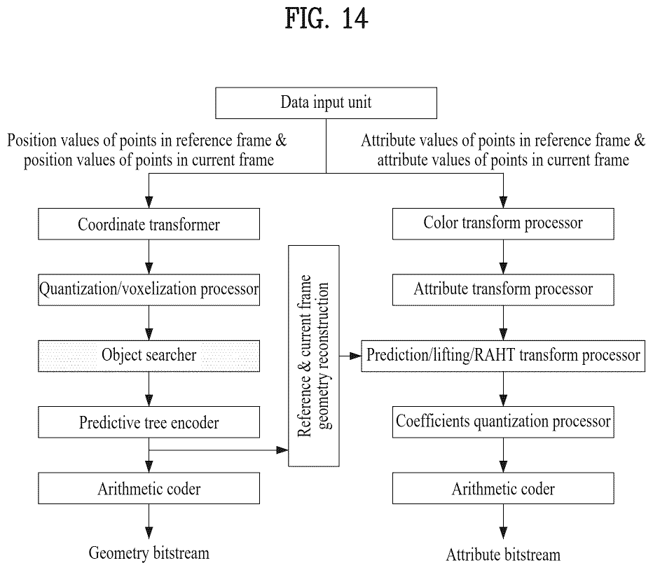

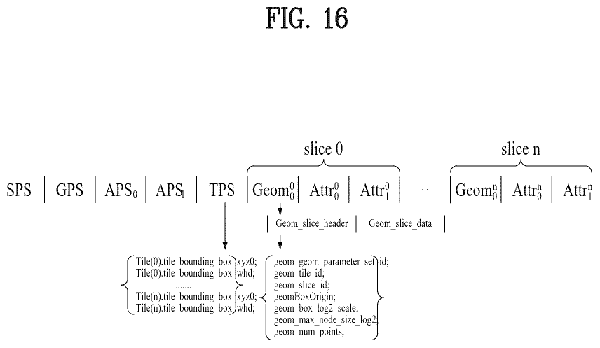

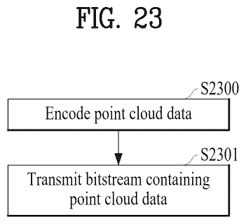

The point cloud data transmission method/device according to the embodiments is to be construed as a term referring to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the prediction-based encoding of FIGS. 11 to 12, the object search-based encoding in FIG. 13, the transmission device (encoder) in FIG. 14, the bitstream/parameter generation in FIGS. 16 to 22, the transmission method in FIG. 23, and the like.

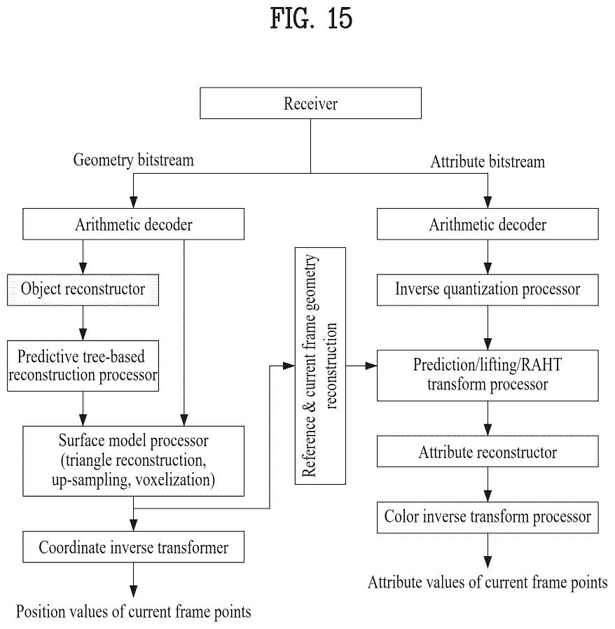

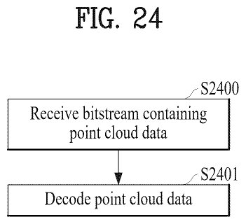

The point cloud data reception method/device according to the embodiments is to be construed as a term referring to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the predictive tree-based decoding in FIGS. 11 to 12, the object search-based decoding in FIG. 14, the reception device (decoder) in FIG. 15, the reception method in FIG. 24, and the like.

Further, the point cloud data transmission and reception methods/devices may be referred to as methods/devices according to the embodiments.

According to embodiments, geometry data, geometry information, position information, and the like that make up the point cloud data are to be construed as having the same meaning. Similarly, attribute data, attribute information, and the like that make up the point cloud data are to be construed as having the same meaning.

According to embodiments, the methods/devices may include a point-by-point search method of object detection in point cloud compression.

Research on inter-frame object detection in a point cloud has been actively conducted, but methods and compression performance for accurate object detection are lacking. Embodiments include a method of compressing an I-frame using intra-frame detection and a point-by-point search method using inter-frame object detection.

To compress 3D point cloud data, embodiments provide an inter-frame object detection method and a point-by-point search method based on geometry information. A dynamic point cloud categorized as Category 3 in the point cloud data may be composed of multiple point cloud frames. Use cases for point cloud data may include self-driving data. In this case, a set of frames is referred to as a sequence. A sequence contains frames composed of the same attribute values. Therefore, geometry values have features of a dynamic object, which makes a movement between frames, and a static object, which makes no movement between frames. In the current standard, object segmentation is not performed, and only inter-frame compression is carried out.

Thus, embodiments propose methods for intra/inter-frame compression targeting inter-frame compression in a Category 3 sequence. The object search method is used within the predictive tree before performing predictive tree compression. The object search is performed after the xyz coordinates are converted to rpl coordinates such as a cylindrical coordinate system with azimuth, radius, and elevation (laser ID). When the predictive tree is compressed in an angular mode, a set of points is sorted by laserID. The points are then sorted by quantized azimuth, and then by quantized radius. The points that are transformed into the RPL coordinate system are included in an object as one point, and individual objects are generated as signaling information and transmitted in parameters by the encoder. Object detection is performed for each frame, and objects in a reference frame may not be present in the object list of the current frame. After the object list is detected, motion estimation and motion compensation are performed for the objects. The motion estimation matrix for each object is generated by the encoder and included in a bitstream to be signaled.

Due to the per-object motion estimation and compensation, the correlation between the current frame and the previous frame may increase, and thus a highly correlated with a small residual may be found. The highly correlated predictor may improve compression efficiency, and the smaller residuals with less data may improve compression efficiency.

FIG. 11 illustrates a predictive tree according to embodiments.

The point cloud data transmission method/device according to the embodiments, which corresponds to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the object search-based encoding in FIG. 13, the transmission device (encoder) in FIG. 14, and the transmission method in FIG. 23, may encode a point cloud using a predictive tree such as that shown in FIG. 11. The predictive tree may be replaced by an octree. The octree may be referred to as an occupancy tree. The occupancy tree is a tree structure that includes nodes in a parent-child relationship from the root level (depth) to the leaf level (depth). A node at one depth may include one or more sub-nodes at the next depth, and an occupancy bit (occupancy information) indicates whether each node occupies a point.

The point cloud data reception method/device according to the embodiments, which corresponds to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the object search-based decoding in FIG. 14, the reception device (decoder) in FIG. 15, and the reception method in FIG. 24, may decode point clouds using a predictive tree such as that shown in FIG. 11.

The predictive tree structure represents the connectivity relationships between points in a point cloud based on xyz coordinates of the point cloud. To construct a predictive tree, the input points are sorted according to a specific criterion, and the predictive tree structure is generated by calculating predicted values according to neighbor nodes based on the rearranged ply. This process establishes a parent-child or higher-lower node relationship between two nodes. The node receiving an arrow is the higher (parent) node, while the node sending the arrow is the lower (child) node.

In some embodiments, an inter-frame prediction method may be used to perform predictive tree-based compression. This method includes selecting one additional prediction point (inter pred point) from the reference frame (the previous frame relative to the current frame) or using two points as additional prediction points (additional inter pred points).

FIG. 12 illustrates an inter-frame predictive tree-based geometry compression/reconstruction method according to embodiments.

The point cloud data transmission method/device according to the embodiments, which corresponds to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the object search-based encoding in FIG. 13, the transmission device (encoder) in FIG. 14, and the transmission method in FIG. 23, may encode the geometry of the point cloud based on an inter-frame predictive tree such as that shown in FIG. 12.

The point cloud data reception method/device according to the embodiments, which corresponds to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the object search-based decoding in FIG. 14, the reception device (decoder) in FIG. 15, and the reception method in FIG. 24, may decode the geometry of the point cloud based on an inter-frame predictive tree such as that shown in FIG. 12.

Objects detected within a frame are managed in an object list. The object list is used for predictive tree encoding. Embodiments propose object search, Intersection over Union (IoU), an IoU threshold, object list sorting, and last index checking.

Referring to FIG. 12, the current frame is the target to be encoded or decoded. The reference frame is a frame encoded or decoded prior to the current frame. Since there is high similarity between the reference and current frames, points from the reference frame may be referenced to predict the points in the current frame.

For example, a point with the same azimuth as a point decoded in the current frame prior to the current point may be found in the reference frame. This is because the points with the same azimuth and/or the same laser ID in the current frame and the reference frame are similar. To increase prediction performance, one point may be selected as a predicted value for the current point based on a rate-distortion optimization (RDO) method. This point may be selected between the point with the next azimuth value (the inter pred point in FIG. 12) for the point found in the reference frame through the search and/or the subsequent point (the additional inter pred point in FIG. 12).

The inter pred point (p′0) and additional inter pred point (p′1) from the reference frame may be referenced. The inter pred point (p′0) is designated as a reference point from the decoded reference frame. It is a point with the same laser ID as the current frame and the most similar azimuth value to the current frame. The additional inter pred point (p′1) has a smaller azimuth than the inter pred point (p′0) and the same laser ID.

Embodiments propose a method for object search in point cloud data using the predictive tree, and also propose a method to improve intra-frame/inter-frame compression. Intra-frame object search may increase compression efficiency by defining coding units differently and selecting predictors for objects. Inter-frame object search may improve compression efficiency through local motion estimation/compensation between objects. The found objects may be classified as dynamic objects, static objects, or roads. Dynamic objects are objects that move dynamically, while static objects are objects that do not move dynamically. Roads refer to streets beneath cars, people, buildings, and the like. Local motion may be performed based on the object is moving or not. The motion of a dynamic object whose movement is dynamic may be estimated and compensated using a local motion vector, while the motion of a static object whose movement is static may be estimated and compensated using a global motion vector. Algorithms such as IoU, feature extractor, classifier, regressor, and Non-Maximum Suppression (NMS) may be used to determine object characteristics. The thresholds for the conditions for the determination may be generated and transmitted as signaling information, allowing the decoder to decode the objects based on the object characteristics found based on the thresholds.

The searched list may be sorted within the object list using bounding boxes for compression. Additionally, when the determination is performed based on the radius, azimuth, and laser ID, points that were not included may be merged into objects by index rechecking.

FIG. 13 illustrates an intra-frame object search method according to embodiments.

The point cloud data transmission method/device according to the embodiments, which corresponds to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the object search-based encoding in FIG. 13, the transmission device (encoder) in FIG. 14, and the transmission method in FIG. 23, may search for and classify objects within frames in detail, as shown in FIG. 13, and efficiently encode the point cloud based on the found objects.

The point cloud data reception method/device according to the embodiments, which corresponds to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the object search-based decoding in FIG. 14, the reception device (decoder) in FIG. 15, and the reception method in FIG. 24, may efficiently decode the point cloud based on the objects found within frames, as shown in FIG. 13.

The methods/devices according to the embodiments may transform the coordinate system for the point cloud. For example, xyz coordinates may be transformed to rpl coordinates, and the intra-frame object search method may be performed. In predictive tree compression, there may be two different cases: coding in the angular mode and coding without using the angular mode. In the embodiments, operations will be described assuming that the angular mode is enabled.

In the angular mode, the points are sorted according to N laserID indices. Specifically, laserID_N may generate N laserIDs. The N indices each have M sorted points. In other words, laserID_N_M represents a set of M points for each laserID. The sorted laserID_N_M is two-dimensionally mapped to the values of azimuth and radius, defined as laserID_N_M_Azi and laserID_N_M_Rad. As shown in FIG. 13, the M points for laserID N have a specific azimuth value. The M points of laser ID N have a specific radius value. [laserID_N_M_Azi, laserID_N_M_Rad] is an array with laserID_N_M elements. The N-th value of the laser ID may identify the point list, and multiple sorted points may be identified within the laser ID index based on radius and azimuth. When considering the relationship between the Cartesian coordinate system and the cylindrical (radius, azimuth, laser ID-based) coordinate system, points belonging to the same laser ID may be points on the same Y-axis in the Cartesian coordinate system. Generally, roads, objects, moving objects, and static objects may be classified and searched for based on the Y-axis. Therefore, as shown in FIG. 13, in the embodiments, the points of an object may be accurately and specifically detected using the laser ID-based coordinate system.

By generating laserID_N_M for the points, the points may be clustered into [laserID_N_M_Azi, laserID_N_M_Rad]. Specifically, point clustering is performed based on the azimuth threshold (laserID_N_M_Azi_th) and the radius threshold (laserID_N_M_Rad_th) within the ranges of laserID_N_M_Azi[0] to laserID_N_M_Azi[laserID_N_M−1] and laserID_N_M_Rad [0] to laserID_N_M_Rad [laserID_N_M−1]. Starting from laserID_N_M_Azi[0], if the condition (laserID_N_M_Azi[x] laserID_N_M_Azi[x+1])<laserID_N_M_Azi_th) for determination is true, the points within the azimuth range may be defined as belonging to the same object. Similarly, f the condition (laserID_N_M_Rad [x]−laserID_N_M_Rad [x+1])<laserID_N_M_Rad_th) for determination is true, the points within the radius range may also be defined as belonging to the same object. Depending on the data characteristics, the determination may be performed using either an AND or OR logic. A set of points clustered as the same object is then generated. The found objects may be identified by an object index (obj_idx), which may be included in a bitstream to be transmitted. The decoder may detect the found objects in detail with reference to the object index information.

In order to merge points that have different laser IDs but can be clustered into the same object, the azimuth (laserID_N_M_Azi) and radius (laserID_N_M_Rad) values of M points with laserID N may be compared. In addition to these comparisons, laserID_N [x] may be compared with laserID [x−1] and laserID [x+1]. If the values are within the azimuth threshold (laserID_N_M_Azi_th) and radius threshold (laserID_N_M_Rad_th), but are assigned to different laserIDs, the points may be clustered into the same object. In this case, there may be a laser ID threshold (laserID_th), which may be the total height of the lasers or a height less thn the total height. A laserID threshold flag (laserID_th_flag) may be defined. When value of laserID_th_flag is TRUE, the laserID threshold (laserID_th) is transmitted over a bitstream as signaling information and used for object clustering. In other words, additional clustering among laserIDs may be performed based on the laserID threshold. The list of objects divided in this manner may be identified by an object index (obj_idx), and the encoder may encode points per detected object or per clustered object. Similarly, the decoder may decode points per detected object or per clustered object. The object index (obj_idx) indicates the number of objects found in the current frame.

The methods/devices according to the embodiments may search for objects between frames.

The inter-frame object search method extends the intra-frame object search method described above. The reference object index (ref_obj_idx) indicates the number of objects found in the reference frame. The methods/devices define object areas using as many bounding boxes with minimum and maximum values as the objects found in the reference frame, and perform object search for the current frame using the method described above. A bounding box list with the minimum and maximum values is created according to the current object index (cur_obj_idx). The minimum value (min) of the bounding boxes for the objects found in the current frame is indicated by cur_obj_idx_min, and the maximum value of the bounding box for cur_obj_idx is indicated by cur_obj_idx_max. Then, the index closest to ref_obj_idx_min and ref_obj_idx_max is searched for. Objects found in the reference frame are classified as static objects, dynamic objects, or roads using an object detection algorithm such as Intersection over Union (IoU), feature extractor, classifier, regressor, or Non-Maximum Suppression (NMS). In the case of the IoU algorithm, when a value obtained by dividing the area of an overlapping region between neighboring regions among the regions generated by the above-mentioned laser ID-based point sorting, search, and clustering by the entire region is less than a threshold (IoU_th), the object in the regions may be initially classified as a dynamic object. The threshold (IoU_th) does not necessarily refer to the value generated by the IoU algorithm. The threshold (IoU_th) represents a threshold used to separate static and dynamic objects after the laserID-based object search described above.

An additional threshold may be used to classify an object as a static object or a road. If laserID is less than the road threshold (IoU_road_th), the object is classified as a road. If laserID is greater than the road threshold (IoU_road_th), the object may be classified as a static object. Static objects and roads are objects with minimal inter-frame motion, and thus local motion estimation/compensation is not performed therefor. However, dynamic objects are subjected to local motion estimation/compensation, and information related to the motion estimation/compensation is generated as signaling/parameter information and transmitted in a bitstream. For example, local motion vectors may be transmitted in the bitstream. Roads are captured with a consistent pattern despite motion, while static objects are influenced by global motion and motions may be considered. For a dynamic object, local motion calculated from the motion of the object may be applied for optimal motion. Therefore, in embodiments, global motion may not be applied for objects classified as roads, but may be applied for objects classified as static objects. Also, local motion may be applied for dynamic objects. This motion compensation based on object characteristics may improve compression efficiency.

If the value of the global motion vector is less than or equal to a threshold, object search may be skipped for the frame. For an object detection skip frame, information such as motion vectors and the min/max bounding box for obj_idx may not be signaled.

The methods/devices described may further merge and split detected objects.

Obj_idx may be merged or split based on the object size, the number of points, and area comparison with a previous frame. Additionally, in two one-dimensional arrays listed as the azimuth range (laserID_N_M_Azi[0] to laserID_N_M_Azi[laserID_N_M−1]) and radius range (laserID_N_M_Rad [0] to laserID_N_M_Rad [laserID_N_M−1]) for M points with laserID N, the first azimuth value of point M of laserID N (laserID_N_M_Azi[0]) and the last azimuth value of point M of laserID N (laserID_N_M_Azi[laserID_N_M−1]) may belong to the same object. The first value of radius for point M of laserID N (laserID_N_M_Rad [0]) and the last value of radius for point M of laserID N (laserID_N_M_Rad [laserID_N_M−1]) may also belong to the same object. Therefore, after performing the object search, it is necessary to determine whether the last point in the array belongs to the same object as the first point. As conditions for this determination, the same azimuth threshold (laserID_N_M_Azi_th) and radius threshold (laserID_N_M_Rad_th) are used. The intra-frame and inter-frame object detection, classification, and clustering may improve the accuracy of object detection by determining whether points belong to the same object.

FIG. 14 illustrates a point cloud data transmission device according to embodiments.

FIG. 14 illustrates a point cloud data transmission method/device according to embodiments, corresponding to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the object search-based encoding in FIG. 13, and the transmission method in FIG. 23. Each component in FIG. 14 may correspond to hardware, software, a processor, and/or a combination thereof.

As shown in FIG. 14, the encoder (which may be referred to as an encoding device, transmission device, etc.) may encode points within a frame or between frames based on the object detection according to the embodiments.

The data input unit acquires point cloud data. In intra-frame coding, the positions (geometry) and attributes of the points in the current frame are encoded, respectively. In inter-frame coding, the geometry in the current frame is encoded by referencing the geometry in the reference frame, and the attributes in the current frame are encoded by referencing the attributes in the reference frame.

The encoding operation of the geometry encoder is described below.

The coordinate transformer may transform the coordinate system of the geometry into a coordinate system suitable for encoding.

The quantization/voxelization processor may quantize and voxelize points based on quantization parameters. The first step in reconstructing the position information about each point in the entire acquired point cloud is quantization of the position information. The minimum x, y, and z position values of all points are found, subtracted from the position values of each point, multiplied by a quantization scale, and rounded to the nearest integer. After the quantization, octree-based voxelization is performed based on the position information about the points to reconstruct each point in the point cloud.

Similar to the pixel, which is the smallest unit having information about a 2D image/video, a voxel is a three-dimensional cubic space created by dividing a 3D space into units (unit=1.0) based on each axis (x, y, z) to store information about the points present in the 3D space. The operation of matching a point in 3D space to a specific voxel is called voxelization. A voxel is a portmanteau of “volume” and “pixel.” The spatial coordinates of a voxel may be estimated based on its positional relationship with a voxel group. Like pixels, voxels may also contain information such as color or reflectance.

The object searcher performs the intra-frame object search method, inter-frame object search method, and object merging/splitting methods according to the embodiments. For example, the object searcher clusters points based on the thresholds for azimuth and radius (laserID_N_M_Azi_th and laserID_N_M_Rad_th). The thresholds are transmitted through the bitstream as parameter information and signaled to the decoder.

When points are within the azimuth threshold (laserID_N_M_Azi_th) and radius azimuth threshold (laserID_N_M_Rad_th), but have different laserIDs, a laserID threshold flag (laserID_th_flag), which is a condition for clustering as the same object, is generated and transmitted in the bitstream. If the value of laserID_th_flag is TRUE, the laserID threshold (laserID_th) is signaled and used for object clustering.

obj_idx indicating the number of objects found by the object searcher is generated and transmitted in the bitstream. For each obj_idx, obj_idx_min and obj_idx_max of the bounding box are transmitted.

To perform inter-frame object search, an object motion flag (obj_motion_flag) may be signaled. The reference object index (ref_obj_idx), which indicates the number of objects in the reference frame, the minimum value of the reference object index (ref_obj_idx_min) and the maximum value of the reference object index (ref_obj_idx_max) of the bounding box for each object are generated and transmitted in the bitstream. Additionally, the current object index (cur_obj_idx), which indicates the number of objects in the current frame, and the minimum value of the current object index (cur_obj_idx_min) and the maximum value of the current object index (cur_obj_idx_max) of the bounding box for each object are generated and transmitted as parameter information in the bitstream.

An object ID (object_id), which indicates each object and/or an object type (object_type), which indicates the characteristics of the object, are generated and transmitted as parameter information in the bitstream. The values of object_id may indicate the following: 0=road, 1=static object, 2=dynamic object, and 3=other objects. Alternatively, object_id may indicate an ID that identifies the object, while object_type may indicate the object type as follows: 0=road, 1=static object, 2=dynamic object, and 3=other objects.

For intra-frames, the predictive tree encoder generates a predictive tree using a detected object within the frame, based on the points. The predictive tree is generated by generating neighbor nodes similar to the current point (node) as sub-nodes (child nodes) of the current node. In encoding the current node, the predicted value with the least error for the current node is found by referencing the parent, grandparent, and grandparent's parent node in the predictive tree, and the residual value is generated, encoded, and transmitted in the bitstream. By finding the most similar predicted value to a static object, a dynamic object, or a road object, only the residual with the minimum size is encoded to increase the compression rate. For inter-frames, a predictive tree is generated using detected objects from both the current frame and the reference frame, which is the frame before the current frame, using an object detected between frames. Based on the similarity between the current frame and the reference frame, predictions may be made from the predictive tree, and only the residual with the smallest size may be encoded. The use of similarities between dynamic objects, static objects, and road objects detected in both the reference and current frames is maximized to increase the compression rate.

The arithmetic coder encodes the residuals using an entropy-based method to encode the geometry.

The geometry encoder generates and transmits a bitstream containing the encoded geometry.

The reference frame and/or current frame geometry reconstructor reconstructs the encoded geometry and delivers the same to the attribute encoder for attribute encoding. The attribute encoder performs the following operations.

The color transformer may transform a system representing color, one of the attributes, into a color system suitable for encoding the attribute. Coding may be performed by changing the color from RGB to YCbCr. Color transform refers to the operation of transforming the color formats

The attribute transform processor transforms the attributes of points that have been repositioned or merged due to voxelization. The attribute transformation may include calculating the average value of an attribute such as color or reflectance of neighbor points within a specific radius from the center position of the voxel, or a weighted average based on the distance from the center position. In this case, each voxel has a position and a calculated attribute value.

The neighbor point transform processor processes prediction, lifting, and RAHT transforms. The prediction transform applies the level of detail (LOD) technique. Each point has an LOD value calculated based on the set LOD distance. Each point in the point cloud may be separated by LOD, and the configuration of points according to each LOD includes points that belong to a lower LOD than the corresponding LOD value. For example, LOD level 2 may include all points that belong to LOD levels 1 and 2.

For the prediction transform, a predictor is created for each point in the point cloud. For details of the prediction transform, refer to the description provided above with reference to FIGS. 5, 6, and the like.

The lifting transform includes generating predictors for each point, setting the calculated LOD for the predictors, registering neighbor points, and assigning weights based on the distance to the neighbor points. The difference from prediction transform lies in the method of cumulatively applying weights to attribute values. For details of the lifting transform, refer the description of FIGS. 5, 6, and the like.

The RAHT is an intra-coding method for attribute information, using an octree backward scan. It predicts the attribute information about higher-level nodes based on the attribute information related to nodes at lower levels of the octree. For details of the RAHT transform, refer the description of FIGS. 5, 6, and the like.

The coefficient quantization processor may quantize the attribute coefficients generated by the prediction/lifting/RAHT transform.

The arithmetic coder encodes the attributes based on an entropy method.

The attribute encoder generates and transmits a bitstream containing the encoded attributes

Based on the type of objects detected in the reference frame, the predictive tree encoder may apply global motion to the current point position value when the type of objects is static, or apply local motion when the type of objects is dynamic. Then, predictive tree encoder may perform inter-prediction.

FIG. 15 illustrates a point cloud data reception device according to embodiments.

FIG. 15 illustrates a point cloud data reception method/device according to embodiments, corresponding to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the object search-based decoding in FIG. 14, and the reception method in FIG. 24. Each component in FIG. 15 may correspond to hardware, software, a processor, and/or a combination thereof.

As shown in FIG. 15, the decoder (which may also be referred to as a decoding device, a reception device, etc.) may decode points within frames or between frames using object detection according to the embodiments.

The decoder in FIG. 15 may perform a reverse process to the operations of the encoder in FIG. 14.

The receiver receives a bitstream containing encoded point cloud data and parameters from the transmission device.

The geometry decoder performs the following operations.

The arithmetic decoder decodes the geometry bitstream based on an entropy method.

The object reconstructor parses the laserID threshold flag (laserID_th_flag), which is a condition that allows points to be clustered as the same object if they are within the threshold values (laserID_N_M_Azi_th and laserID_N_M_Rad_th) but have different laserIDs. When the value of laserID_th_flag is TRUE, the object reconstructor parses the laserID threshold (laserID_th) and the object index (obj_idx), which indicates the number of objects detected from the bitstream. It parses from the bitstream the minimum and maximum values of the object indices (obj_idx_min, obj_idx_max) in the bounding box per object index (obj_idx).

To determine whether inter-frame object search is performed, the object motion flag (obj_motion_flag) is parsed from the bitstream. The reference object index (ref_obj_idx), which indicates the number of objects in the reference frame, and the minimum value of the reference object index (ref_obj_idx_min) and the maximum value of the reference object index (ref_obj_idx_max) of the bounding box for each object are parsed from the bitstream. The current object index (cur_obj_idx), which indicates the number of objects in the current frame, and the minimum value of the current object index (cur_obj_idx_min) and the maximum value of the current object index (cur_obj_idx_max) of the bounding box for each object are parsed from the bitstream.

An object ID (object_id), which indicates each object and/or an object type (object_type), which indicates the characteristics of the object, are generated and transmitted as parameter information in the bitstream. The values of object_id may indicate the following: 0=road, 1=static object, 2=dynamic object, and 3=other objects. Alternatively, object_id may indicate an ID that identifies the object, while object_type may indicate the object type as follows: 0=road, 1=static object, 2=dynamic object, and 3=other objects.

The predictive tree-based reconstructor, similar to the transmission device, may generates a predictive tree for the point cloud and generate predicted values according to intra-frames or inter-frames based on the predictive tree. The encoded and transmitted residuals may be summed with the predicted values to reconstruct the geometry.

The surface model processor may use the surface model to reconstruct the positions of points in the node region based on voxels. For details of the surface model processing, refer to the description of FIG. 4 and related figures.

The coordinate inverse transformer may inversely transform the transformed coordinates generated for encoding at the transmitter side.

The geometry decoder reconstructs the position values of points in the current frame.

The reference frame and/or current frame geometry reconstructor may reconstruct the geometry for attribute decoding and deliver the same to the attribute decoder, as described with reference to FIG. 7.

The attribute decoder may perform the following operations.

The arithmetic decoder may decode attributes contained in the received bitstream using an entropy method.

The inverse quantization processor may inversely quantize the attributes in a reverse process to the quantization of attributes performed by the transmission device.

As described with reference to FIG. 7, the prediction/lifting/RAHT transform processor may apply at least one of the prediction transform, lifting transform, or RAHT to the attributes, similarly to the transmitting side.

The attribute reconstructor may reconstruct attributes in the reverse process to the attribute transform in FIG. 14.

The color inverse transformer may tansform colors in the reverse process to the color transform in FIG. 14.

Based on the position values of points in the reference frame, objects may be segmented by determining whether their position values fall within the range defined by the minimum reference object index (ref_obj_idx_min) and the maximum reference object index (ref_obj_idx_max). Alternatively, objects already segmented in the previous frame may be retained as reference frame objects and applied to reconstruct the current frame.

Based on the type of objects detected in the reference frame, a global motion may be applied to the position values of the current point when the type of the object is static, or a local motion may be applied when the type of the object is dynamic. Then, the predictive tree-based reconstruction processor may perform inter-predictive reconstruction.

FIG. 16 illustrates a bitstream containing point cloud data and parameters according to embodiments.

The point cloud data transmission method/device according to the embodiments, which corresponds to the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the object search-based encoding in FIG. 13, the transmission device (encoder) in FIG. 14, and the transmission method in FIG. 23, may generates and transmits a bitstream as shown in FIG. 16.

The point cloud data reception method/device according to the embodiments, which corresponds to the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the object search-based decoding in FIG. 14, the reception device (decoder) in FIG. 15, and the reception method in FIG. 24, may receive a bitstream as shown in FIG. 16, and decodes the point cloud based on parameters.

Signaling may be performed to add/perform intra-frame/inter-frame encoding/decoding methods based on object detection. The parameters (which may be referred to as metadata, signaling information, etc.) may be generated in the process of a transmitter according to embodiments described below, and transmitted to a receiver according to embodiments so as to be used in the reconstruction process. For example, the parameters according to the embodiments may be generated by the metadata processor (or metadata generator) in the transmission device according to embodiments described below and acquired by the metadata parser in the reception device.

Each of the following abbreviations means: SPS: Sequence Parameter Set; GPS: Geometry Parameter Set; APS: Attribute Parameter Set; TPS: Tile Parameter Set; Geom: Geometry bitstream=geometry data unit (geometry data unit header+geometry data+geometry data+geometry data unit footer); Attr: Attribute bitstream=attribute data unit (attribute data unit header+attribute data+attribute data unit footer).

The point cloud may be divided into regions, such as tiles or slices, for processing. Each region have a different level of importance. Depending on the importance, different filters or filter units may be applied, allowing a filtering method with higher complexity but higher quality results to be used in important regions. Instead of applying complex filtering methods to the entire point cloud, different filtering methods may be applied to different regions (tiled or sliced regions) according to the processing capacity of the receiver, thus ensuring better quality for the regions that are important to the user and adequate latency in the system. Therefore, when a point cloud is divided into tiles, different filters or filter units may be applied to the respective tiles. When a point cloud is divided into slices, different filters or filter units may be applied to the respective slices.

Referring to FIG. 14, a bitstream a target unit to which parameters are applied and may include an SPS, a GPS, one or more APSs, a TPS, and one or more slices. The TPS may include information about the origin and size (width, depth, and height) of the tile bounding box for one or more tiles. A slice serves as a unit of encoding/decoding and may include geometry and one or more attributes. The geometry may be composed of a geometry slice header and geometry slice data. A slice may also be referred to as a data unit. The geometry slice header or geometry data unit header carries information such as the parameter set ID, tile ID, slice ID, origin and size of the geometry box, and the number of points for the geometry. The geometry slice data or geometry data unit carries the encoded geometry.

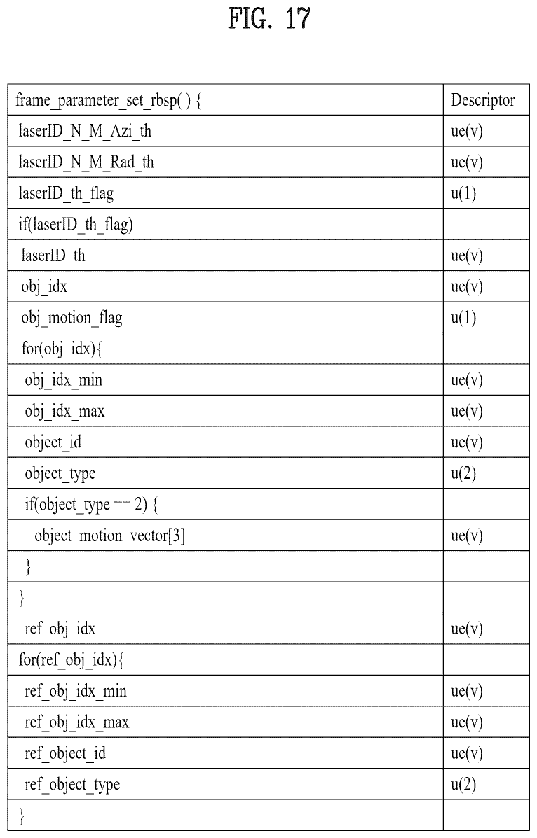

FIG. 17 illustrates a frame parameter set (FPS) according to embodiments.

The FPS shown in FIG. 17 represents the frame parameter set in the bitstream in FIG. 16. Embodiments may add object detection-based intra-frame/inter-frame structure information to the FPS.

laserID_N_M_Azi_th: Indicates the threshold for azimuth in the object searcher. It indicates the azimuth threshold for points with laserID N.

laserID_N_M_Rad_th: Indicates the threshold for radius in the object searcher. It indicates the radius threshold for points with laserID N.

laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max.

ref_object_id: Indicates the identifier for the object in the reference frame.

ref_object_type: Indicates the object type information that indicates the characteristics of the object in the reference frame. For example, the values may indicate the following: 0=road, 1=static object, 2=dynamic object, and 3=other objects.

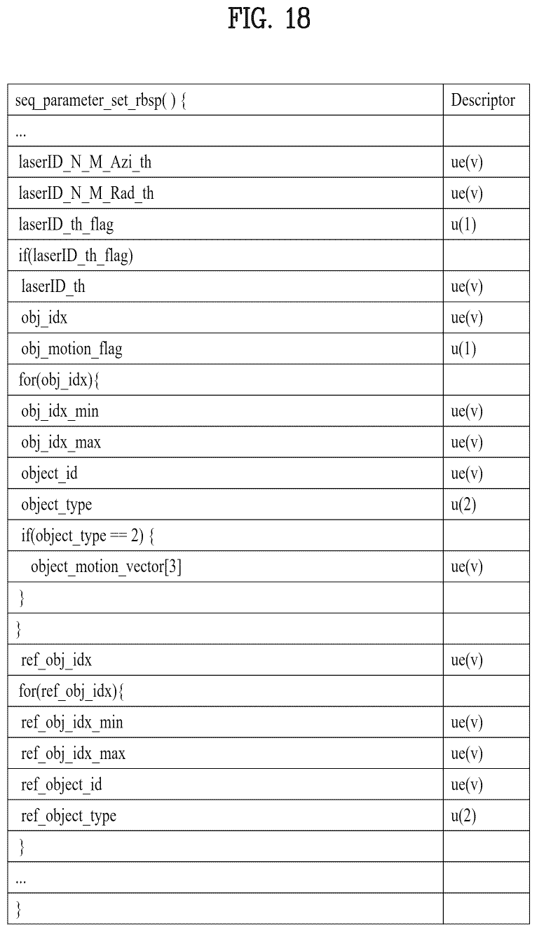

FIG. 18 illustrates a sequence parameter set (SPS) according to embodiments.

FIG. 18 illustrates the sequence parameter set in the bitstream of FIG. 16. Intra-frame/inter-frame structure information based on object detection may be added to the SPS.

laserID_N_M_Azi_th: Indicates the threshold for azimuth in the object searcher. It indicates the azimuth threshold for points with laserID N.

laserID_N_M_Rad_th: Indicates the threshold for radius in the object searcher.

It indicates the radius threshold for points with laserID N. laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max.

ref_object_id: Indicates the identifier for the object in the reference frame.

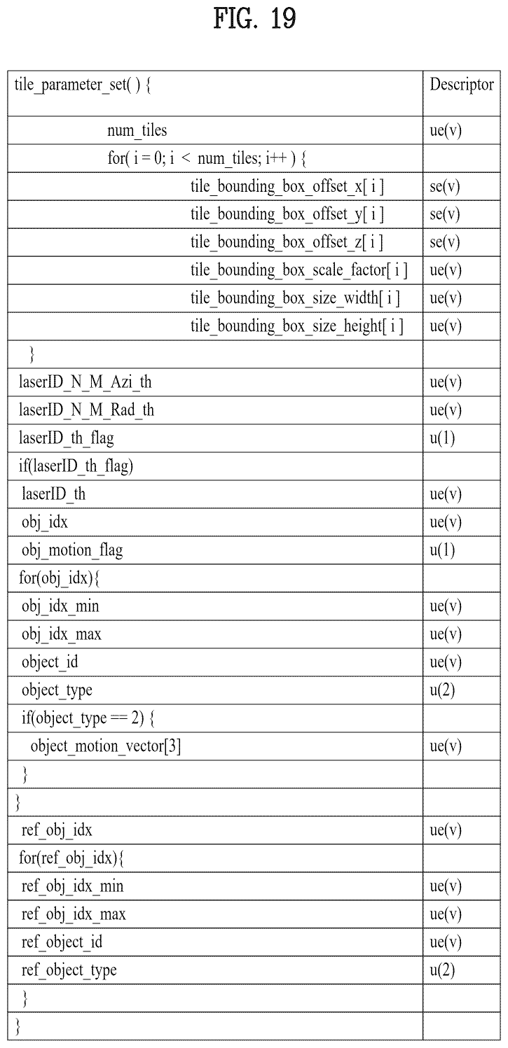

ref_object_type: Indicates the object type information that indicates the characteristics of the object in the reference frame. For example, the values may indicate the following: 0=road, 1=static object, 2=dynamic object, and 3=other objects. FIG. 19 illustrates a tile parameter set (TPS) according to embodiments.

FIG. 19 illustrates the tile parameter set in the bitstream of FIG. 16. Intra-frame/inter-frame encoding structure information based on object detection may be added to the TPS.

num_tiles: Indicates the number of tiles

tile_bounding_box_offset_x, y, z: Indicates the offset values of x, y, and z that represent the origin of the tile bounding box.

tile_bounding_box_scale_factor: Indicates the scale factor applied to the tile bounding box.

tile_bounding_box_size_width: Indicates the width as the size of the tile bounding box.

tile_bounding_box_size_height: Indicates the height as the size of the tile bounding box.

tile_bounding_box_size_depth: Indicates the depth as the size of the tile bounding box.

laserID_N_M_Azi_th: Indicates the threshold for azimuth in the object searcher. It indicates the azimuth threshold for points with laserID N.

laserID_N_M_Rad_th: Indicates the threshold for radius in the object searcher. It indicates the radius threshold for points with laserID N.

laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max.

ref_object_id: Indicates the identifier for the object in the reference frame.

ref_object_type: Indicates the object type information that indicates the characteristics of the object in the reference frame. For example, the values may indicate the following: 0=road, 1=static object, 2=dynamic object, and 3=other objects.

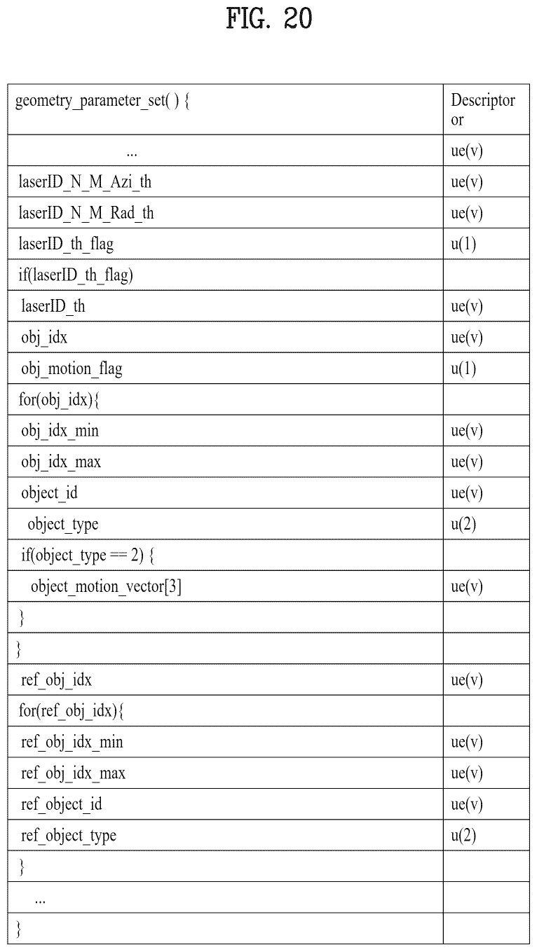

FIG. 20 illustrates a geometry parameter set (GPS) according to embodiments.

FIG. 20 illustrates the geometry parameter set in the bitstream of FIG. 16. Intra-frame/inter-frame encoding structure information based on object detection may be added to the GPS.

laserID_N_M_Azi_th: Indicates the threshold for azimuth in the object searcher. It indicates the azimuth threshold for points with laserID N.

laserID_N_M_Rad_th: Indicates the threshold for radius in the object searcher. It indicates the radius threshold for points with laserID N.

laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

object_id: Indicates an ID representing the representing the object characteristics. The value of object_id indicates the type of object: 0=road, 1=static object, 2=dynamic object, 3=other objects. The object_id element may be replaced by the object_type element.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max.

ref_object_id: Indicates the identifier for the object in the reference frame.

ref_object_type: Indicates the object type information that indicates the characteristics of the object in the reference frame. For example, the values may indicate the following: 0=road, 1=static object, 2=dynamic object, and 3=other objects.

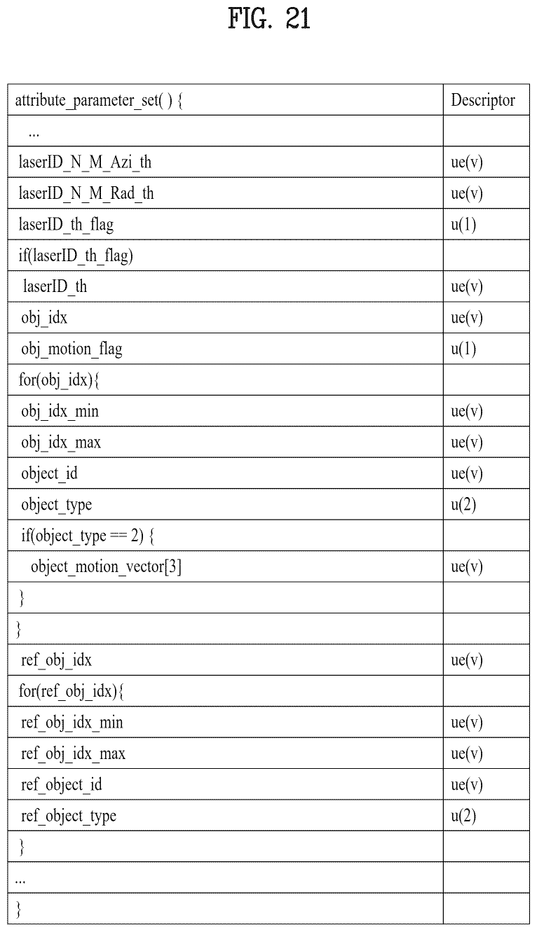

FIG. 21 illustrates an attribute parameter set (APS) according to embodiments.

FIG. 21 illustrates the attribute parameter set in the bitstream of FIG. 16. Intra-frame/inter-frame encoding structure information based on object detection may be added to the APS.

laserID_N_M_Azi_th: Indicates the threshold for azimuth in the object searcher. It indicates the azimuth threshold for points with laserID N.

laserID_N_M_Rad_th: Indicates the threshold for radius in the object searcher. It indicates the radius threshold for points with laserID N.

laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max.

ref_object_id: Indicates the identifier for the object in the reference frame.

ref_object_type: Indicates the object type information that indicates the characteristics of the object in the reference frame. For example, the values may indicate the following: 0=road, 1=static object, 2=dynamic object, and 3=other objects.

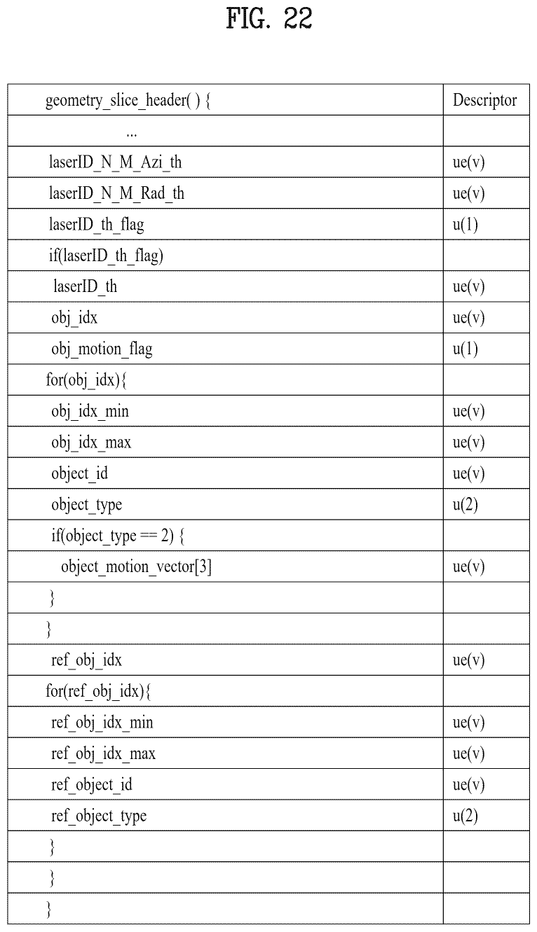

FIG. 22 illustrates a geometry slice header (GSH) according to embodiments.

FIG. 22 illustrates the geometry slice header in the bitstream of FIG. 16. Intra-frame/inter-frame encoding structure information based on object detection may be added to the slice header of the geometry part (Geom) in the bitstream. A slice may be referred to as a data unit, and the slice header may be referred to as a data unit header.

laserID_N_M_Azi_th: Indicates the threshold for azimuth in the object searcher. It indicates the azimuth threshold for points with laserID N.

laserID_N_M_Rad_th: Indicates the threshold for radius in the object searcher. It indicates the radius threshold for points with laserID N.

laserID_th_flag: Indicates a condition under which different LaserIDs can be clustered into the same object. When true, it indicates that the laserID threshold (laserID_th) is transmitted and used for object clustering. When false, it indicates the laserID threshold (laserID_th) is not transmitted and object clustering is not used.

obj_idx: Indicates the number of objects detected by the object searcher for the current frame.

obj_motion_flag: Indicates whether object search is performed between frames.

obj_idx_min and obj_idx_max: Indicate the bounding box for each object in the current frame. The bounding box may be indicated by the values of obj_idx_min and obj_idx_max.

object_id: Indicates an ID for an object. The ID may be used to identify an object with specific characteristics.

object_type: Indicates the type representing the object characteristics. Based on the value of object_type, the object is identified. Each type value may indicate: 0=road, 1=static object, 2=dynamic object, and 3=other objects. An object may be identified by object_id, and the object may have characteristics classified into road, static object, dynamic object, or other objects. The encoder generates information based on the type and deliver the same to the decoder.

object_motion_vector[3]: Indicates the motion vector of the object when the object is a dynamic object.

ref_obj_idx: Indicates the number of objects found in the reference frame by the object searcher.

ref_obj_idx_min and ref_obj_idx_max: Indicate the bounding box for each object in the reference frame. The bounding boxes of the objects in the reference frame may be indicated by the values of ref_obj_idx_min and ref_obj_idx_max. ref_object_id: Indicates the identifier for the object in the reference frame.

ref_object_type: Indicates the object type information that indicates the characteristics of the object in the reference frame. For example, the values may indicate the following: 0=road, 1=static object, 2=dynamic object, and 3=other objects.

FIG. 23 illustrates a point cloud data transmission method according to embodiments.

S2300: The point cloud data transmission method according to the embodiments may include encoding point cloud data.

The encoding operation according to the embodiments includes the operations of the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the predictive tree-based encoding of FIGS. 11 to 12, the laser ID-based object search in FIG. 13, the transmission device (encoder) in FIG. 14, the bitstream generation in FIGS. 16 to 22, and the like.

S2301: The point cloud data transmission method according to the embodiments may further include transmitting a bitstream containing the point cloud data.

The transmission operation according to the embodiments includes the operations of the transmission device 10000, the point cloud video encoder 10002, the transmitter 10003 in FIG. 1, the acquisition 20000-encoding 20001-transmission 20002 in FIG. 2, the encoder in FIG. 3, the transmission device in FIG. 8, the devices in FIG. 10, the predictive tree-based encoding of FIGS. 11 to 12, the laser ID-based object search in FIG. 13, the transmission device (encoder) in FIG. 14, the bitstream transmission in FIGS. 16 to 22, and the like.

FIG. 24 illustrates a point cloud data reception method according to embodiments.

S2400. The point cloud data reception method according to the embodiments may include receiving a bitstream containing point cloud data.

The reception operation according to the embodiments includes the operations of the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the predictive tree-based encoding in FIGS. 11 to 12, the laser ID-based object search in FIG. 13, the reception device (decoder) in FIG. 15, and the reception of the bitstream in FIGS. 16 to 22.

The reception device and decoder and the bitstream reception in FIGS. 14 to 22 are included in the reception operation according to the embodiments.

S2401: The point cloud data reception method according to the embodiments may further include decoding the point cloud data.

The decoding operation according to the embodiments includes the operations of the reception device 10004, the receiver 10005, the point cloud video decoder 10006 in FIG. 1, the transmission 20002-decoding 20003-rendering 20004 in FIG. 2, the decoder in FIG. 7, the reception device in FIG. 9, the devices in FIG. 10, the predictive tree-based encoding in FIGS. 11 to 12, the laser ID-based object search in FIG. 13, the reception device (decoder) in FIG. 15, and the decoding of the bitstream in FIGS. 16 to 22.

Referring to FIG. 1, the point cloud data transmission method according to the embodiments may include encoding point cloud data; and transmitting a bitstream containing the point cloud data.

Referring to FIG. 14, regarding the object searcher, the encoding of the point cloud data may include encoding geometry of the point cloud data, wherein the encoding of the geometry may include searching for objects based on the geometry.

Referring to FIG. 13, regarding coordinate transformation and intra-frame object search, the encoding of the geometry may include transforming coordinates of points in the point cloud data from a Cartesian coordinate system to radius, azimuth, and laser ID. The points may be sorted based on a value of the laser ID. The points for the value of the laser ID may be clustered based on the radius and the azimuth, and objects for the points may be classified based on at least one of a threshold for the azimuth or a threshold for the radius.

Referring to FIG. 13, regarding the coordinate transformation and intra-frame object search, referring to the conditions for determination, (laser ID_N_M_Azi[x]−laser ID_N_M_Azi[x+1])<laser ID_N_M_Azi_th and/or (laser ID_N_M_Rad [x]−laser ID_N_M_Rad [x+1])<laser ID_N_M_Rad_th), based on that a difference in the azimuth between a first point of the points for the laser ID and a second point of the points for the laser ID is less than the threshold for the azimuth, or a difference in the radius between the first point of the points for the laser ID and the second point of the points for the laser ID is less than the threshold for the radius, or based on that the difference in the azimuth between the first point of the points for the laser ID and the second point of the points for the laser ID is less than the threshold for the azimuth, and the difference in the radius between the first point of the points for the laser ID and the second point of the points for the laser ID is less than the threshold for the radius, the first point and second point may be detected as the same object.

Referring to FIG. 11, regarding the predictive tree and intra-frame prediction, the encoding of the point cloud data may include generating a predictive tree for points in the point cloud data, generating predicted values for the geometry of the point cloud data based on the predictive tree, generating residuals based on the predicted values, encoding the residuals, wherein the generating of the predictive tree may include sorting the points, finding a neighbor node for a first point among the sorted points and adding the found neighbor node as a child node to a node of the first point.

Referring to FIGS. 11 to 12, regarding the predictive tree and inter-frame prediction (Inter pred point (p′0) and additional inter pred point (p′1)), the encoding of the point cloud data may include generating a predictive tree for points in a current frame containing the point cloud data, generating predicted values for the geometry of the point cloud data from reference points in a reference frame for the current frame based on the predictive tree, generating residuals based on the predicted values, and encoding the residuals. The reference points may include a first point having an azimuth equal to an azimuth of a point in the current frame and having a similar azimuth to the point in the current frame, and a second point having a laser ID identical to a laser ID of the first point and having an azimuth less than the azimuth of the first point.

Regarding inter-frame object search, the encoding of the point cloud data may include encoding geometry of the point cloud data, wherein the encoding of the geometry may include detecting a dynamic objects based on a proportion of an overlapping region between a bounding box region of an object found from a reference frame for a current frame containing the point cloud data and a bounding box region of an object found from the current frame being greater than a threshold, detecting a static object and a road object based on the proportion being less than the threshold, wherein the static object and the road object are classified based on an additional threshold and laser ID, applying a local motion to the dynamic object, and applying a global motion to the static objects.

Regarding object merging/splitting, based on that a difference in the azimuth between a leading point and a last point among the points for the laser ID is less than the threshold for the azimuth, the leading point and the last point may be detected as the same object. Based on that a difference in the radius between the leading point and the last point among the points for the laser ID is less than the threshold for the radius, the leading point and the last point may be detected as the same object. Alternatively, based on that the difference in the azimuth between the leading point and the last point among the points for the laser ID is less than the threshold for the azimuth, and the difference in the radius between the leading point and the last point among the points for the laser ID is less than the threshold for the radius, the leading point and the last point may be detected as the same object.

Referring to FIGS. 16 to 22, regarding signaling, the bitstream may contain at least one of a threshold for an azimuth, a threshold for a radius, a flag related to a threshold for a laser ID, information indicating a number of objects, information indicating whether object search is performed between frames, information indicating a bounding box of an object in a current frame, information identifying the object, information indicating a type of the object, a motion vector for a dynamic object, information indicating a number of objects in a reference frame, information indicating bounding boxes of the objects in the reference frame, information identifying the objects in the reference frame, or information indicating types of the objects in the reference frame.

The point cloud data transmission method may be performed by a transmission device. Referring to FIG. 14, the point cloud data transmission device may include an encoder configured to encode point cloud data, and a transmitter configured to transmit a bitstream containing the point cloud data. The transmission device may include a memory and a processor. The memory may store instructions related to the encoding operation, and the instructions may cause the processor to perform the encoding operation on point cloud data.

Referring to FIG. 15, a point cloud reception method is the reverse of the transmission method and may include: receiving a bitstream containing point cloud data and decoding the point cloud data.

The decoding of the point cloud data may include decoding geometry of the point cloud data, wherein the decoding of the geometry may include searching for an object based on the geometry.

The decoding of the geometry may include transforming coordinates of points in the point cloud data from a Cartesian coordinate system to radius, azimuth, and laser ID. The points may be sorted based on a value of the laser ID. The points for the value of the laser ID may be clustered based on the radius and the azimuth, and objects for the points may be classified based on at least one of a threshold for the azimuth or a threshold for the radius.

The point cloud data reception method may be performed by a reception device. Referring to FIG. 15, the point cloud data reception device may include a receiver configured to receive a bitstream containing point cloud data, and a decoder configured to decode the point cloud data. The reception device may include a memory and a processor. The memory may store instructions for the decoding operation, and the instructions may cause the processor to perform the decoding operation on the point cloud data.

The decoder may perform operations including decoding geometry of the point cloud data, wherein the decoding of the point cloud data may include searching for objects from the geometry.

Embodiments may provide a method for object detection during point cloud compression and improve coding performance. As the inter-frame/intra-frame object search method is proposed, compression efficiency of the predictive tree may be enhanced using a compression method that reflects object characteristics, which was not implemented with conventional technologies.

The embodiments have been described in terms of a method and/or a device, and the description of the method and the description of the device may be applied complementary to each other.

Although the accompanying drawings have been described separately for simplicity, it is possible to design new embodiments by combining the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In the present disclosure, “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to perform the related operation or interpret the related definition according to a specific condition when the specific condition is satisfied.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

As described above, related details have been described in the best mode for carrying out the embodiments.

As described above, the embodiments are fully or partially applicable to a point cloud data transmission/reception device and system.

Those skilled in the art may change or modify the embodiments in various ways within the scope of the embodiments.

Embodiments may include variations/modifications within the scope of the claims and their equivalents.

1. A method of transmitting point cloud data, the method comprising:
encoding point cloud data; and
transmitting a bitstream containing the point cloud data.

2. The method of claim 1, wherein the encoding of the point cloud data comprises:
encoding geometry of the point cloud data,
wherein the encoding of the geometry comprises:
searching for an object based on the geometry.

3. The method of claim 2, wherein the encoding of the geometry comprises:
transforming coordinates of points in the point cloud data from a Cartesian coordinate system to radius, azimuth, and laser ID,
wherein:
the points are sorted based on a value of the laser ID;
the points for the value of the laser ID are clustered based on the radius and the azimuth;
objects for the points are classified based on at least one of a threshold for the azimuth or a threshold for the radius.

4. The method of claim 3, wherein, based on that:
a difference in the azimuth between a first point of the points for the laser ID and a second point of the points for the laser ID is less than the threshold for the azimuth; or
a difference in the radius between the first point of the points for the laser ID and the second point of the points for the laser ID is less than the threshold for the radius, or
based on that:
the difference in the azimuth between the first point of the points for the laser ID and the second point of the points for the laser ID is less than the threshold for the azimuth; and
the difference in the radius between the first point of the points for the laser ID and the second point of the points for the laser ID is less than the threshold for the radius,
the first point and second point are detected as the same object.

5. The method of claim 2, wherein the encoding of the point cloud data comprises:
generating a predictive tree for points in the point cloud data;
generating predicted values for the geometry of the point cloud data based on the predictive tree;
generating residuals based on the predicted values;
encoding the residuals,
wherein the generating of the predictive tree comprises:
sorting the points; and
finding a neighbor node for a first point among the sorted points and adding the found neighbor node as a child node to a node of the first point.

6. The method of claim 2, wherein the encoding of the point cloud data comprises:
generating a predictive tree for points in a current frame containing the point cloud data;
generating predicted values for the geometry of the point cloud data from reference points in a reference frame for the current frame based on the predictive tree;
generating residuals based on the predicted values; and
encoding the residuals,
wherein the reference points comprise:
a first point having an azimuth equal to an azimuth of a point in the current frame and having a similar azimuth to the point in the current frame; and
a second point having a laser ID identical to a laser ID of the first point and having an azimuth less than the azimuth of the first point.

7. The method of claim 1, wherein the encoding of the point cloud data comprises:
encoding geometry of the point cloud data,
wherein the encoding of the geometry comprises:
detecting a dynamic objects based on a proportion of an overlapping region between a bounding box region of an object found from a reference frame for a current frame containing the point cloud data and a bounding box region of an object found from the current frame being greater than a threshold;
detecting a static object and a road object based on the proportion being less than the threshold, wherein the static object and the road object are classified based on an additional threshold and laser ID;
applying a local motion to the dynamic object; and
applying a global motion to the static objects.

8. The method of claim 4, wherein:
based on that a difference in the azimuth between a leading point and a last point among the points for the laser ID is less than the threshold for the azimuth, the leading point and the last point are detected as the same object;
based on that a difference in the radius between the leading point and the last point among the points for the laser ID is less than the threshold for the radius, the leading point and the last point are detected as the same object; or
based on that the difference in the azimuth between the leading point and the last point among the points for the laser ID is less than the threshold for the azimuth, and the difference in the radius between the leading point and the last point among the points for the laser ID is less than the threshold for the radius, the leading point and the last point are detected as the same object.

9. The method of claim 1, wherein the bitstream contains at least one of:
a threshold for an azimuth;
a threshold for a radius;
a flag related to a threshold for a laser ID;
information indicating a number of objects;
information indicating whether object search is performed between frames;
information indicating a bounding box of an object in a current frame;
information identifying the object;
information indicating a type of the object;
a motion vector for a dynamic object;
information indicating a number of objects in a reference frame;
information indicating bounding boxes of the objects in the reference frame;
information identifying the objects in the reference frame; or
information indicating types of the objects in the reference frame.

10. A device for transmitting point cloud data, comprising:
an encoder configured to encode point cloud data; and
a transmitter configured to transmit a bitstream containing the point cloud data.

11. A method of receiving point cloud data, the method comprising:
receiving a bitstream containing point cloud data; and
decoding the point cloud data.

12. The method of claim 11, wherein the decoding of the point cloud data comprises:
decoding geometry of the point cloud data,
wherein the decoding of the geometry comprises:
searching for an object based on the geometry.

13. The method of claim 12, wherein the decoding of the geometry comprises:
transforming coordinates of points in the point cloud data from a Cartesian coordinate system to radius, azimuth, and laser ID,
wherein:
the points are sorted based on a value of the laser ID;
the points for the value of the laser ID are clustered based on the radius and the azimuth;
objects for the points are classified based on at least one of a threshold for the azimuth or a threshold for the radius.

14. A device for receiving point cloud data, comprising:
a receiver configured to receive a bitstream containing point cloud data; and
a decoder configured to decode the point cloud data.

15. The device of claim 14, wherein the decoder performs operations comprising:
decoding geometry of the point cloud data,
wherein the decoding of the point cloud data comprises:
searching for objects from the geometry.
